(19) United States
(12) Patent Application Publication
(10) Pub. No.: US 2023/0305728 A1
(43) Pub. Date: Sep. 28, 2023

(54) MANAGEMENT SYSTEM, STORAGE SYSTEM, AND MANAGEMENT PROCESSING METHOD

(71) Applicant: Hitachi, Ltd., Tokyo (JP)

(72) Inventors: Kenta SATO, Tokyo (JP); Kazuei HIRONAKA, Tokyo (JP); Akira DEGUCHI, Tokyo (JP)

(73) Assignee: Hitachi, Ltd., Tokyo (JP)

(21) Appl. No.: 18/119,480

(22) Filed: Mar. 9, 2023

(30) Foreign Application Priority Data
Mar. 28, 2022 (JP) 2022-052614

(51) Int. Cl. G06F 3/06

(52) U.S. Cl. CPC G06F 3/0647; G06F 3/0604; G06F 3/067

(57) ABSTRACT

A processor repeatedly collects integrated management information related to a storage apparatus and including performance data indicating an operation status of the storage apparatus that stores data, and stores the performance data in an performance data temporary storage area. In addition, the processor analyzes the integrated management information, and determines the importance level indicating the degree of the influence of the performance data stored in the performance data temporary storage area on the analysis process of analyzing the performance data. The processor migrates the performance data stored in the performance data temporary storage area to one of the plurality of long-term storage areas having different characteristics based on the importance level.

### BACKGROUND OF THE INVENTION

### 1. Field of the Invention

The present disclosure relates to a management system, a storage system, and a management processing method.

### 2. Description of the Related Art

In recent years, storage management systems configured to manage storage apparatuses have advanced in order to facilitate operation and management of the storage apparatuses. For example, as a storage management system, there is known a system having a function of detecting a problem occurring in a storage apparatus and a problem that is likely to occur in the future and notifying a user or an administrator who uses the storage apparatus. In addition, a function of generating an optimal remediation plan for the detected problem and proposing the optimal remediation plan to the administrator, a function of automatically executing the generated remediation plan, and the like are also proposed.

The above-described functions are realized as the storage management system collects and analyzes configuration information, performance data, and the like of the storage apparatus. In addition, there are many problems that can be detected by these functions, and a vendor that provides the storage apparatus continuously expands problems to be detected by analyzing the configuration information, the performance data, and the like collected from a large number of the storage apparatuses actually operated by a customer.

In this manner, in the storage management system, to collect and analyze the configuration information, the performance data, and the like of the storage apparatus is extremely important for the user and the administrator of the storage apparatus and for the vendor that provides the storage apparatus in order to provide the advanced functions. For this reason, in recent years, storage management systems are often provided by software as a service (SaaS) constructed on a cloud by a vendor of a storage apparatus in order to collect information from a large number of the storage apparatuses. This type of storage management systems accumulate the collected information such as configuration information and performance data collected from the storage apparatuses on the cloud, and analyzes the collected information on the cloud, thereby providing the above-described advanced functions.

For example, U.S. patent Ser. No. 11/216,317 discloses a technique for detecting a problem such as a deviation of a processor load in a storage apparatus and generating and executing a proposed remediation plan for the problem based on configuration information and performance data.

### SUMMARY OF THE INVENTION

Not only short-term analysis using the latest performance data but also analysis of past long-term performance data is important in order to detect various problems occurring in storage apparatuses. This is because it is not possible to determine whether a detected problem is a temporary problem that does not need to be addressed or a problem that needs to be addressed only by the short-term analysis. Therefore, the performance data collected from the storage apparatus needs to be stored for a long period.

The performance data is generally time-series data generated at regular time intervals for various performance metrics of various resources constituting each of the storage apparatuses. For this reason, when the performance data of each of a large number of the storage apparatuses is stored for a long period, the amount of data becomes enormous, and a storage cost thereof is not ignorable.

For example, if 8 bytes of performance data per metric is generated at a cycle of 5 minutes in a case where there are 5000 resources in each of 10,000 units of storage apparatuses and there are 10 metrics per resource, a data amount of the performance data generated in one year is 8 [byte/metric]×10 [metric/resource]×5000 [resource/storage apparatus]×10,000 [units]×(60/5) [times/hour]×24 [hour/day]×30 [day/month]×12 [month/year]=377 [TB/year]. For this reason, for example, when the performance data is stored in units of years, the amount of data to be stored easily reaches a petabyte scale, and thus, the storage cost is not ignorable.

The technique described in U.S. patent Ser. No. 11/216,317 focuses on a method of detecting and addressing a problem based on analysis using long-term performance data, and does not consider a storage cost for storing the long-term performance data used for the analysis.

As a method for reducing the storage cost, a method of using a low-cost storage section is conceivable. In the low-cost storage section, however, it takes time to access data as compared with a normal storage section, and an additional cost is required for data extraction, and thus, it is difficult to simply use the low-cost storage section. In addition, a method of compressing data is also conceivable, but in the case of this method, calculation is necessary for compression and decompression of data, the storage cost is transferred to a calculation cost. In addition, a method of migrating old performance data to an archive using optical media and the like is conceivable. However, even the old performance data needs to be periodically read in order to perform data analysis over a long period, and thus, there is a possibility that the data analysis is hindered in storage in the archive that requires time for reading and preparation.

Some recent information technology (IT) devices have a function of realizing an inexpensive and high-performance storage section by combining a low-cost and low-performance storage section and a high-cost and high-performance storage section. This function is called a cache, tiering, or the like, and is realized by a configuration in which a cache memory (static random access memory (SRAM)) and a main memory (dynamic RAM (DRAM)) in a central processing unit (CPU) are combined, or realized by a configuration in which a solid state drive (SSD) and a hard disk drive (HDD) in a storage apparatus are combined.

However, the function is a function that utilizes reference locality of data, and realize the inexpensive and high-performance storage section by selectively using a storage section for storing data according to a frequency of access to the data. For this reason, in the analysis based on the long-term performance data, pieces of performance data included in a wide temporal range to be analyzed are uniformly accessed, and thus, a difference hardly occurs in the frequency of access to each piece of the performance data, and the above-described function does not work effectively.

An object of the present disclosure is to provide a management system, a storage system, and a management processing method capable of reducing a storage cost for storing performance data while suppressing an influence on an analysis process of analyzing the performance data.

A management system according to one aspect of the present disclosure is a management system that performs an analysis process of analyzing performance data indicating an operation status of a storage apparatus that stores data, the management system including a processor, and the processor executes a collection process of repeatedly collecting management information related to the storage apparatus and including the performance data and storing the performance data in a temporary storage area, an importance level determination process of analyzing the management information and determining an importance level indicating a degree of an influence of the performance data stored in the temporary storage area on the analysis process, and a migration process of migrating the performance data stored in the temporary storage area to one of a plurality of long-term storage areas having different characteristics based on the importance level.

According to the present invention, it is possible to reduce the storage cost for storing the performance data while suppressing the influence on the analysis process of analyzing the performance data.

### BRIEF DESCRIPTION OF THE DRAWINGS

FIG. 1 is a diagram for describing an overall image of the present disclosure;

FIG. 2 is a diagram illustrating a configuration example of a storage system;

FIG. 3 is a diagram illustrating a configuration example of a management system;

FIG. 4 is a diagram illustrating a configuration example of a storage apparatus;

FIG. 5 is a view illustrating a configuration example of organization information;

FIG. 6 is a view illustrating a configuration example of device information;

FIG. 7 is a view illustrating a configuration example of a configuration information structure;

FIG. 8 is a view illustrating a configuration example of a pool information structure;

FIG. 9 is a view illustrating a configuration example of a volume information structure;

FIG. 10 is a view illustrating a configuration example of a port information structure;

FIG. 11 is a view illustrating a configuration example of a host connection information structure;

FIG. 12 is a view illustrating an example of performance data;

FIG. 13 is a view illustrating an example of manipulation history information;

FIG. 14 is a view illustrating an example of event history information;

FIG. 15 is a view illustrating an example of performance data provision history information;

FIG. 16 is a flowchart for describing an example of a collection and storage process;

FIG. 17 is a flowchart for describing a problem point detection process;

FIG. 18 is a flowchart for describing an example of a storage destination selection process;

FIG. 19 is a flowchart for describing an example of an importance level determination process;

FIG. 20 is a flowchart for describing a provision process; and

FIG. 21 is a flowchart for describing a storage destination review process.

### DESCRIPTION OF THE PREFERRED EMBODIMENTS

Hereinafter, embodiments of the present disclosure will be described with reference to the drawings. However, the following description and drawings are examples for describing the present invention, and omission and simplification will be appropriately made for clarification of the description, and do not limit the technical scope of the present invention. In the following description, various types of information will be described using expressions such as a “structure” and a “table”, but various types of information may be expressed using a data structure other than these. In addition, expressions such as an “identification information”, an “identifier”, a “name”, an “ID”, and a “number” are used when describing contents of various types of information, and these expressions can be replaced with each other.

In the following description, a description will be sometimes made with a “program” as a subject, but the subject of the description may be rephrased with a processor since the program is executed by the processor (for example, a central processing unit (CPU), a graphics processing unit (GPU), or the like) to perform defined processing while appropriately using a storage resource (for example, memory), an interface device (for example, a communication device), and the like. Similarly, the subject of the processing performed by executing the program may be a controller, a device, a system, a computer, a node, a storage apparatus, a server, a client, a host, or the like having the processor. In addition, a part or all of the program may be processed using a specific hardware circuit. In addition, various programs may be installed in each of computers by a program distribution server or storage media. In addition, in the following description, two or more programs may be realized as one program, or conversely, one program may be realized as two or more programs.

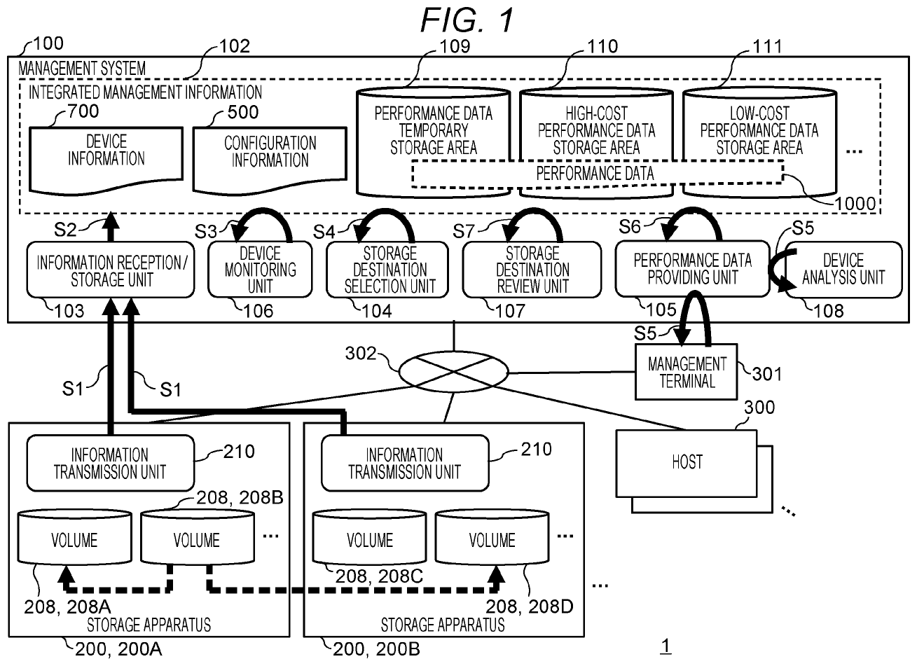

FIG. 1 is a diagram illustrating a configuration of a storage system according to an embodiment of the present disclosure. A storage system 1 illustrated in FIG. 1 includes a management system 100, a plurality of storage apparatuses 200, a host 300, and a management terminal 301, which are connected to each other via a network 302.

The management system 100 includes an information reception and storage unit 103, a storage destination selection unit 104, an performance data providing unit 105, a device monitoring unit 106, a storage destination review unit 107, and a device analysis unit 108. Each of the units 103 to 108 is realized by a control program to execute various processes with reference to integrated management information 102. The integrated management information 102 includes configuration information 500, device information 700, and performance data 1000.

In addition, the management system 100 includes an performance data temporary storage area 109, a high-cost performance data storage area 110, and a low-cost performance data storage area 111 as areas for storing the performance data 1000, and the performance data 1000 is stored in any of these areas.

The performance data temporary storage area 109 is a temporary storage area for temporarily storing the performance data 1000 received from the storage apparatus 200. The high-cost performance data storage area 110 and the low-cost performance data storage area 111 are long-term storage areas for long-term storage of the performance data 1000 for which a predetermined period has elapsed since storage in the performance data temporary storage area 109, and have different characteristics. Note that the characteristics include a cost for storing data, performance for accessing data, and the like. In the present embodiment, the high-cost performance data storage area 110 is a first storage area having a higher cost for storing data and higher performance for accessing data, and the low-cost performance data storage area 111 is a second storage area having a lower cost and lower performance as compared with the high-cost performance data storage area 110.

The storage apparatus 200 is a device that stores data, and provides the host 300 with a volume 208 that is a logical storage area. In addition, the storage apparatus 200 includes an information transmission unit 210 configured to transmit various types of information. Note that the number of the storage apparatuses 200 is not particularly limited. As the storage apparatus 200, two storage apparatuses 200A and 200B are illustrated in FIG. 1.

In addition, the storage apparatus 200 may have a function of synchronizing data between a plurality of the volumes 208 for the purpose of data backup or the like. In the example of FIG. 1, a volume 208A and a volume 208B of the storage apparatus 200A form a copy pair for synchronizing data, and data is copied from the volume 208B to the volume 208A. In addition, the copy pair may be configured across a plurality of the storage apparatuses 200 for the purpose of high availability or the like. In the example of the drawing, the storage apparatus 200A and the storage apparatus 200B form a copy pair (more specifically, the volume 208B of the storage apparatus 200A and a volume 208D of the storage apparatus 200B), and data is copied from the volume 208B to the volume 208D.

The host 300 executes various processes and instructs the storage apparatus 200 to read and write data according to the processes. Note that the number of the hosts 300 is not particularly limited.

The management terminal 301 is a terminal configured to perform management work and the like of the storage system 1, and for example, acquires the performance data 1000 from the management system 100 and performs analysis and the like.

Hereinafter, processing performed by the storage system 1 in steps S1 to S7 will be described.

In step S1, the storage apparatus 200 transmits various types of information including the configuration information 500 and the performance data 1000 to the management system 100. For example, the information transmission unit 210 of the storage apparatus 200 periodically aggregates various types of information of the own device and transmits the information as management information to the management system 100 via the network 302.

In step S2, the information reception and storage unit 103 of the management system 100 receives the information from the storage apparatus 200 and stores the information in the integrated management information 102. Specifically, the information reception and storage unit 103 updates the configuration information 500, the device information 700, and the performance data 1000 according to a type of the received information. In addition, the information reception and storage unit 103 stores the performance data 1000 in the performance data temporary storage area 109.

In step S3, the device monitoring unit 106 monitors the performance data 1000 stored in the performance data temporary storage area 109 and detects the presence or absence of an event related to the storage apparatus 200. The event is, for example, a problem point (failure, abnormality, or the like), and the device monitoring unit 106 detects the presence or absence of the event by performing analysis that can be performed only with the performance data 1000 in a short period, such as whether a value of the performance data 1000 exceeds a threshold or whether an abrupt variation occurs in the value of the performance data 1000.

In step S4, the storage destination selection unit 104 executes a storage destination selection process which is a migration process of migrating the performance data 1000 stored in the performance data temporary storage area 109 to either the high-cost performance data storage area 110 or the low-cost performance data storage area 111 1000. A storage destination is determined using a monitoring status in step S3, the integrated management information 102, and the like.

In step S5, the performance data providing unit 105 receives a reference request for the performance data 1000 stored in the high-cost performance data storage area 110 and the low-cost performance data storage area 111 from the device analysis unit 108 and the management terminal 301.

In step S6, the performance data providing unit 105 performs a reference process of providing the performance data 1000 requested to be referred to by the reference request to the device analysis unit 108 or the management terminal 301 which is a request source of the reference request. The device analysis unit 108 or the management terminal 301 that has received the performance data 1000 executes an analysis process of analyzing the performance data. In the analysis process, long-term analysis of various states of the storage apparatus 200 or the like is performed.

In step S7, the storage destination review unit 107 changes storage destinations of pieces of the performance data 1000 stored in the high-cost performance data storage area 110 and the low-cost performance data storage area 111 according to importance levels calculated from provision frequencies of the pieces of the performance data 1000 by the performance data providing unit 105. This processing is periodically performed, for example.

Hereinafter, the storage system 1 will be described in more detail.

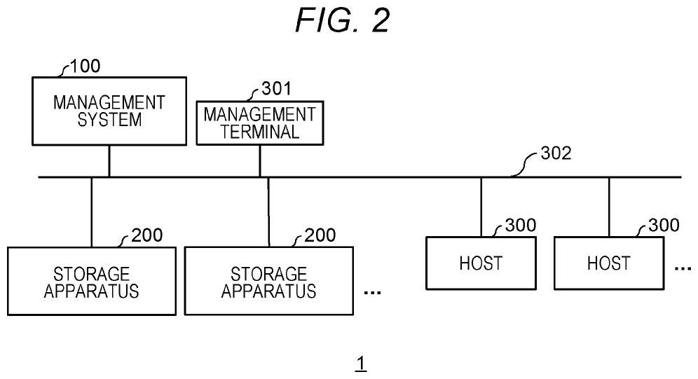

FIG. 2 is a diagram illustrating a configuration example of the storage system 1. As illustrated in FIG. 2, the storage system 1 includes one or more storage apparatuses 200, one or more hosts 300, one or more management terminals 301, and the management system 100. These constituent elements constituting the storage system 1 do not need to be installed at the same point. For example, the storage apparatus 200 and the host 300 may be installed in a data center of a customer, the management system 100 may be installed in a cloud prepared by a vendor of the storage apparatus 200, and the management terminal 301 may be carried by an administrator of the storage apparatus 200. Similarly, a plurality of constituent elements may be physically realized in a single device. For example, functions of the management system 100, the storage apparatus 200, and the host 300 may be mounted on one physical server using a hyper converged infrastructure (HCI).

In addition, the respective constituent elements are connected to each other via the network 302 to be capable of communicating with each other. The network 302 is realized by a communication line such as Ethernet, InfiniBand, and an optical fiber, or a combination thereof. In addition, the network 302 may include not only a local area network (LAN) closed in a data center, but also a wide area network (WAN) such as the Internet, a virtual network inside a computer, and the like. Although not illustrated, the network 302 may include network devices such as a network switch, a router, and a gateway as necessary. Although all the constituent elements are connected to one network 302 in FIG. 2, a dedicated network used between specific constituent elements may be provided. For example, a storage area network (SAN) using a fibre channel may be provided to connect the storage apparatus 200 and the host 300 at a high speed.

The management system 100 is a system that collects and analyzes the configuration information 500 and the performance data 1000 from the storage apparatus 200 to detect an event related to the storage apparatus 200 and generate a remediation plan for the event, thereby reducing the burden on an administrator of the storage system 1. In the present embodiment, the management system 100 is configured to operate on a cloud prepared by a vendor providing the storage apparatus 200, but is not limited to this configuration. For example, the management system 100 may be realized by, for example, a cloud such as a public cloud or a private cloud prepared by a customer, a normal server device, or the like. A computing environment on the cloud may be a physical server or a virtualized environment such as virtual machine or container. In addition, the management system 100 may be configured using a service that executes a program without being conscious of a computing environment such as Function-as-a-Service (FaaS) Serverless Computing, or may be configured by combining a plurality of these computing environments.

The management terminal 301 is used by a user or the administrator of the storage system 1, the vendor that provides the storage apparatus 200, or the like to acquire information from the management system 100 or give an instruction to the storage apparatus 200 via the management system 100. The management terminal 301 is realized by, for example, a desktop computer, a laptop computer, a tablet computer, a smartphone, or the like.

Management software which is a program (computer program) for managing the storage system 1 is installed in the management terminal 301, and the administrator and a customer of the storage system 1 communicate with the management system 100 via the management software. The management software may be a web application. In this case, the management system 100 has a function of a web server, distributes a program constituting the management software with respect to access from the management terminal 301, and the administrator and the customer of the storage system 1 perform various processes by accessing the web application from a web browser or the like installed in the management terminal 301. Although not specifically described in the present embodiment, the management terminal 301 may directly communicate with the storage apparatus 200 to acquire some information or give an instruction.

The host 300 is a computer configured to perform various work processes by executing an installed application program. The host 300 transmits a data read request or write request to the storage apparatus 200 in response to a request from the application program.

The storage apparatus 200 is a device that provides a storage area configured to read and write data from and to the host 300. In addition, the storage apparatus 200 communicates with the management system 100, transmits the configuration information 500, the performance data 1000, and the like of the own device, and changes a configuration and a state of the own device in response to an instruction from the management terminal 301 via the management system 100.

The above-described configuration of the storage system 1 is merely an example, and the storage system 1 is not limited to this configuration. For example, the storage system 1 can include various constituent elements as necessary in addition to the illustrated constituent elements.

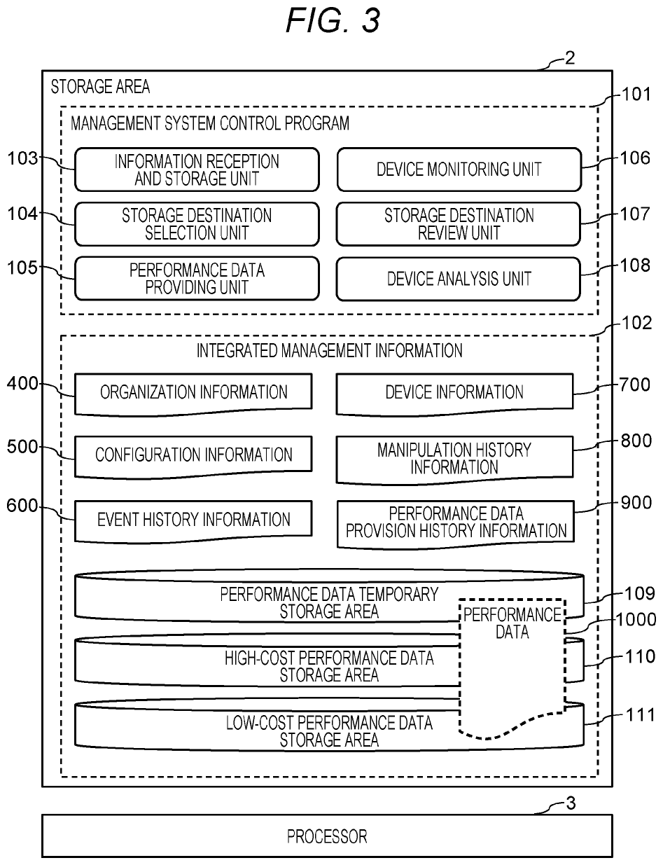

FIG. 3 is a diagram illustrating a configuration example of the management system 100. The management system 100 includes a storage area 2 and a processor 3. Although not illustrated, the management system 100 may include an interface that is connected to the network 302 and communicates with the management terminal 301, the storage apparatus 200, and the like, a display device that displays various types of information, an input device that receives various types of information, and the like.

The storage area 2 is realized by, for example, a storage apparatus corresponding to a computing environment in which the management system 100 operates, such as a memory and an auxiliary storage apparatus, and stores a management system control program 101 and the integrated management information 102.

The management system control program 101 is a computer program that defines operations of the processor 3, and is executed by the processor 3 to realize the information reception and storage unit 103, the storage destination selection unit 104, the performance data providing unit 105, the device monitoring unit 106, the storage destination review unit 107, and the device analysis unit 108. The units may be realized by separate programs, respectively. In addition, the respective programs are read and executed by the processor 3 in response to communication from the storage apparatus 200 and the management terminal 301 or time. The processor 3 is, for example, a CPU or the like, reads the management system control program 101, executes the read management system control program 101, and executes various processes using the integrated management information 102.

The information reception and storage unit 103 communicates with the storage apparatus 200 via the network 302, and stores various types of information from the storage apparatus 200 in an appropriate area of the integrated management information 102 according to a type of the information. The storage destination selection unit 104 selects either the high-cost performance data storage area 110 or the low-cost performance data storage area 111 as a long-term storage destination of the performance data 1000 stored in the performance data temporary storage area 109, and migrates the performance data to the selected area. The performance data providing unit 105 reads the performance data 1000 requested from the management terminal 301, the device analysis unit 108, and the like from the performance data temporary storage area 109, the high-cost performance data storage area 110, and the low-cost performance data storage area 111, and provides the read performance data to a request source.

The device monitoring unit 106 monitors the performance data 1000 stored in the performance data temporary storage area 109 to detect the presence or absence of an event related to the storage apparatus 200. The storage destination review unit 107 changes storage destinations of pieces of the performance data 1000 stored in the high-cost performance data storage area 110 and the low-cost performance data storage area 111 based on provision statuses to the management terminal 301 and the device analysis unit 108. The device analysis unit 108 executes an analysis process of analyzing the performance data 1000 and various types of information in the integrated management information 102 acquired via the performance data providing unit 105 to detect a state (such as a problem point) of the storage apparatus 200 and generate a remediation plan according to the state. A specific content of the analysis process is not particularly limited. As the analysis process, for example, an existing technique such as the technique disclosed in U.S. patent Ser. No. 11/216,317 can be applied.

The integrated management information 102 includes organization information 400, the configuration information 500, event history information 600, the device information 700, manipulation history information 800, performance data provision history information 900, and the performance data 1000, and is read and written by the management system control program 101. The performance data 1000 is stored in the performance data temporary storage area 109, the high-cost performance data storage area 110, and the low-cost performance data storage area 111. The management system 100 may have other programs and information as necessary.

The organization information 400 is information for managing an organization and a user who use the management system 100. The configuration information 500 is information for managing parameters, setting values, and the like of the respective storage apparatuses 200. The event history information 600 is information for managing an event related to the storage apparatus 200. The event indicates processing results of the device monitoring unit 106 and the device analysis unit 108, and the like.

The device information 700 is information for managing the storage apparatus 200. The manipulation history information 800 is information for managing a history of a manipulation performed in each of the storage apparatuses 200. The performance data provision history information 900 is information for managing a history of the performance data 1000 provided by the performance data providing unit 105. The performance data 1000 indicates an operation status of each of the storage apparatuses 200.

In the present embodiment, three storage areas, that is, the performance data temporary storage area 109, the high-cost performance data storage area 110, and the low-cost performance data storage area 111 are prepared as areas for storing the performance data 1000. A specific configuration method of these storage areas is not particularly limited. However, a storage area with high access performance is suitable in spite of a high cost required for data storage since a frequency of access to data stored in the performance data temporary storage area 109 and the high-cost performance data storage area 110 is high, and a storage area with a low cost required for data storage is suitable in spite of low access performance since a frequency of access to data stored in the low-cost performance data storage area 111 is low.

The storage area having the high cost and high access performance is realized by, for example, an SSD or an HDD, and the storage area having the low cost and low access performance is realized by, for example, an archive using a tape or an optical medium. However, a difference in characteristics of the storage areas is relative, and an SSD may be used for the high-cost performance data storage area 110 and an HDD may be used for the low-cost performance data storage area 111.

In addition, the above three storage areas may be realized by using a plurality of storage services provided by a public cloud vendor. For example, a high-performance storage service may be used as the performance data temporary storage area 109 and the high-cost performance data storage area 110, and a low-performance storage service may be used as the low-cost performance data storage area 111. In addition, the low-cost performance data storage area 111 may be a storage area installed in a remote place where an operation cost is low and connected by an Internet line, or may be a storage area in which access performance is lowered by applying a data compression technique or the like. In addition, a format of storing the performance data 1000 may be different for each storage area. For example, the performance data temporary storage area 109 and the high-cost performance data storage area 110 may store data in a database format such that the data can be accessed at a high speed, and the low-cost performance data storage area 111 may store data as a simple comma separated value (CSV) file.

The above-described configuration of the management system 100 is merely an example, and the management system 100 is not limited to this configuration. For example, the management system 100 can include various constituent elements as necessary in addition to the illustrated constituent elements.

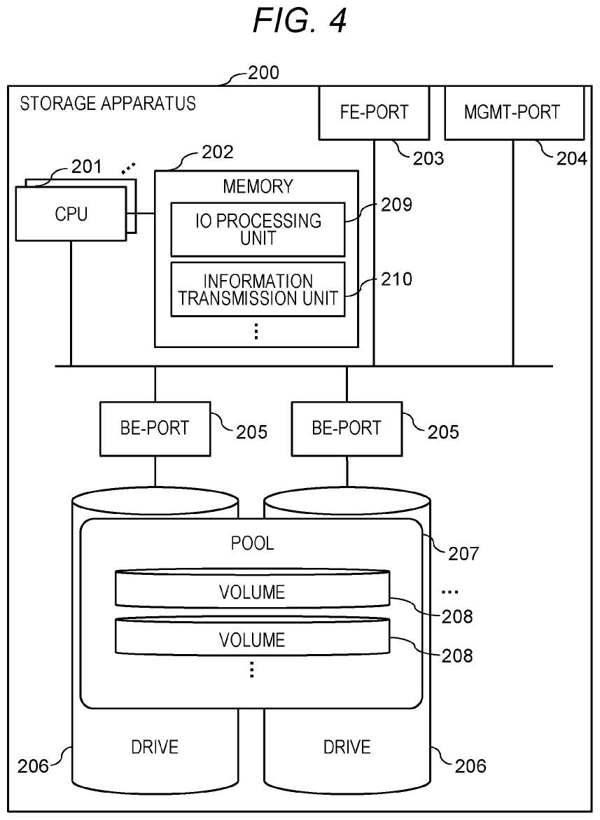

FIG. 4 is a diagram illustrating a configuration example of the storage apparatus 200. The storage apparatus 200 illustrated in FIG. 4 includes one or more CPUs 201, one or more memories 202, one or more frontend ports (FE-PORTs) 203, one or more management ports (MGMT-PORTs) 204, one or more backend ports (BE-PORTs) 205, and one or more drives 206, and the respective constituent elements are connected via an internal bus.

The CPU 201 is a control device controlled by the storage apparatus 200, and executes various processes by executing various programs stored in the memory 202.

The memory 202 stores a program that defines operations of the CPU 201 and various types of information used and generated in processing performed by the program. In the example of FIG. 4, the program is used to realize an IO processing unit 209 and the information transmission unit 210. The memory 202 includes a dynamic random access memory (DRAM), and is generally connected to the CPU 201 using a synchronous DRAM (SDRAM) or its successor memory standard. However, the memory 202 may include, for example, a storage medium such as a magnetoresistive RAM (MRAM), a resistive RAM (ReRAM), or a phase change memory (PCM).

The FE-PORT 203 is a port (network interface) configured for connection with the host 300 via the network 302. When a SAN is used to connect the host 300 and the storage apparatus 200 to each other at a high speed, the FE-PORT 203 is connected to the SAN and communicates with the host 300. The MGMT-PORT 204 is a port configured for connection with the management system 100 and the management terminal 301 via the network 302. Note that PCI Express is generally used for connection of the CPU 201 with the FE-PORT 203 and the MGMT-PORT 204, but other communication standards may be used.

The drive 206 is a device having a physical storage area, and includes, for example, a non-volatile storage medium such as an HDD, an SSD, and a storage class memory (SCM), and is connected to the BE-PORT 205 via an interface such as a serial attached SCSI (SAS), a serial ATA (SATA), or a non-volatile memory express (NVMe). Note that a plurality of the BE-PORTs 205 may be connected to one drive 206, or a plurality of the drives 206 may be connected to one BE-PORT 205. PCI Express is generally used for connection between the CPU 201 and the BE-PORT 205, but other communication standards may be used.

The storage apparatus 200 configures a pool 207 which is one or more volume pools by logically bundling one or more drives 206. Examples of a technique of bundling the drives 206 include just a bunch of disks (JBOD) simply linking storage areas of the drives 206, and a reliability improving technique such as redundant arrays of independent disks (RAID).

The storage apparatus 200 configures one or more volumes 208 by cutting out a part of a storage area from the pool 207. The volume 208 is a logical storage area provided by the storage apparatus 200 to the host 300 and into which data is written from the host 300. The data written by the host 300 into the volume 208 is stored in the drive 206 via the pool 207.

Note that the storage apparatus 200 may have a thin provisioning function of allocating a physical storage area only to an area where access has occurred, a data compression function of compressing written data and then writing the compressed data to the drive 206, a deduplication function of detecting and removing duplicated data from the pool 207, a quality of service (QoS) function capable of setting a lower limit value and an upper limit value with respect to a processing speed at which data is read and written, a local copy function of configuring a copy pair using two volumes 208 inside the same storage apparatus 200 and copying data between the copy pair, a remote copy function of forming a copy pair using two volumes 208 across the two storage apparatuses 200 and copying data between the copy pair, and the like.

Data read and write processes and the above-described various functions in the storage apparatus 200 are appropriately realized by the 10 processing unit 209.

Hereinafter, various types of information constituting the integrated management information 102 will be described.

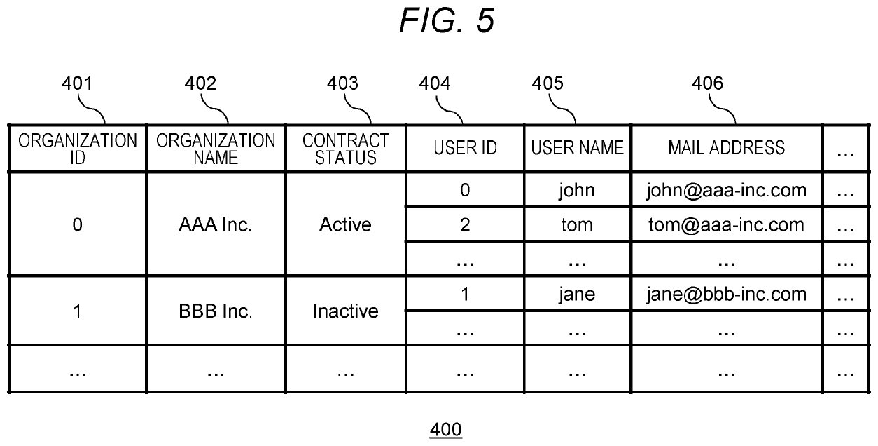

FIG. 5 is a view illustrating an example of the organization information 400. In the present embodiment, a contract for using the management system 100 is concluded with an organization that owns the storage apparatus 200. The organization information 400 is information for managing the organization that has the contract for using the management system 100 and a user belonging to the organization. Each entry of the organization information 400 includes fields 401 to 406.

The field 401 stores an organization ID which is identification information for identifying an organization using the management system 100. The field 402 stores an organization name indicating a name of the organization. The field 403 stores a contract status with the organization. In the example of FIG. 5, the contract status indicates either “Active” indicating that a maintenance contract of the storage apparatus 200 is concluded or “Inactive” indicating that the maintenance contract of the storage apparatus 200 has expired. However, in a case where the maintenance contract is concluded, the contract status may represent types of the contract such as “Active (Premium)” and “Active (Basic)”. The field 404 stores a user ID which is identification information for identifying a user belonging to the organization. The field 405 stores a user name indicating a name of the user. The field 406 stores a mail address of the user as a contact address of the user. In the example of FIG. 5, the organization ID and the user ID are represented by consecutive numbers, but may be represented by numbers that are not consecutive numbers, or may be represented by characters other than numbers.

In the example of FIG. 5, an organization of which the organization ID is “0” has an organization name “AAA Inc.”, and a contract status thereof is “Active”. In addition, a user having a user ID “0”, a user name “john”, and a mail address “john@aaa-inc.com” belongs to the organization.

The entry of the organization information 400 is added when a use contract is concluded between a vendor of the storage apparatus 200 that provides the management system 100 and an organization. Note that the organization information 400 may include other information such as a contract period, payment information, and authentication information for accessing the management system 100.

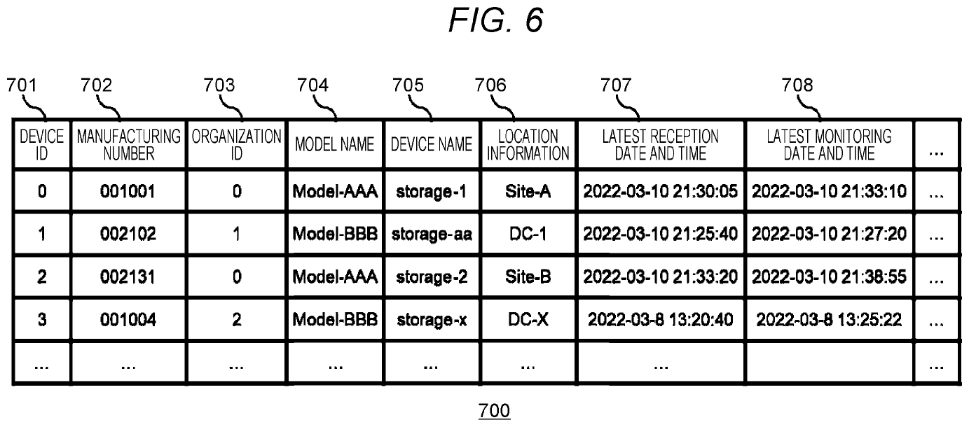

FIG. 6 is a view illustrating an example of the device information 700. The device information 700 is information for managing the storage apparatus 200 managed by the management system 100. Each entry of the device information 700 includes fields 701 to 708.

The field 701 stores a device ID that is identification information for the management system 100 to identify the storage apparatus 200. In the example of FIG. 6, the device ID is represented by consecutive numbers, but may be represented by numbers that are not consecutive numbers, or may be represented by characters other than numbers. The field 702 stores a manufacturing number that is identification information given at the time of manufacturing the storage apparatus 200. The field 703 stores an organization ID of an organization that owns the storage apparatus 200. The field 704 stores a model name indicating a model of the storage apparatus 200. The field 705 stores a device name which is a name of the storage apparatus 200, and the field 706 stores location information indicating an installation location of the storage. The device name and the location information are used by the organization that owns the storage apparatus 200 to easily identify the storage apparatus 200. The field 707 stores latest reception date and time that is date and time when the information reception and storage unit 103 of the management system 100 received information from the storage apparatus 200 last. The field 708 stores latest monitoring date and time which is the date and time when the device monitoring unit 106 of the management system 100 performed a monitoring process on the storage apparatus 200 last.

In the example of FIG. 6, the storage apparatus 200 having a device ID “0” is owned by an organization of which the manufacturing number is “001001” and the organization ID is “0”, and has a model name “Model-AAA”, a device name “storage-1”, location information “site-A”, latest reception date and time “2022-03-10 21:30:05”, and latest monitoring date and time “2022-03-10 21:33:10”.

The entry of the device information 700 is added when the storage apparatus 200 is newly added as a management target of the management system 100. In addition, the device name, the location information, and the latest reception date and time are updated when the information reception and storage unit 103 receives information from the storage apparatus 200. The latest monitoring date and time is updated when the device monitoring unit 106 performs a monitoring process on the storage apparatus 200.

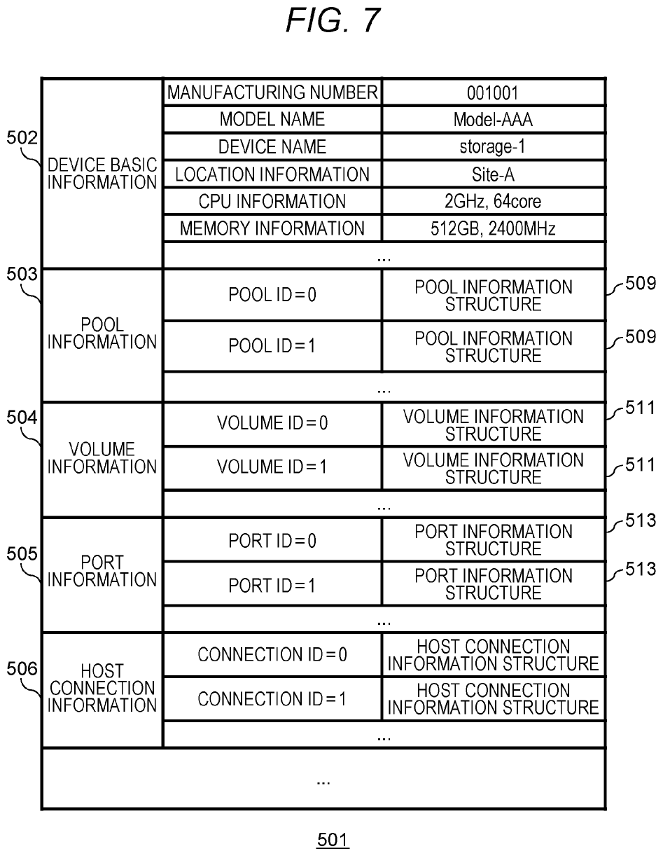

FIG. 7 is a diagram illustrating an example of a configuration information structure. A configuration information structure 501 illustrated in FIG. 7 exists for each of the storage apparatuses 200. The configuration information structure 501 of each of the storage apparatuses 200 registered in the device information 700 is stored in the configuration information 500 in the integrated management information 102. In the present embodiment, the configuration information 500 is treated as a structure, but a data structure of the configuration information 500 is not limited to this example. For example, the configuration information 500 may be stored in a predetermined file system or object storage, may be normalized and stored in a relational database management system (RDBMS), or may be stored in a NoSQL-type database.

The configuration information structure 501 includes device basic information 502, pool information 503, volume information 504, port information 505, and host connection information 506.

The device basic information 502 indicates basic matters related to the storage apparatus 200. The device basic information 502 includes a manufacturing number, a model name, a device name, location information, CPU information, and memory information. The CPU information is information related to the CPU 201 mounted on the storage apparatus 200, and indicates a frequency, the number of cores, and the like. In addition, the CPU information may indicate a model number of the CPU 201 or the like. The memory information is information related to the memory 202 mounted on the storage apparatus 200, and indicates a capacity, an operating frequency, and the like. The memory information may indicate a model number of the memory 202, the number of memory modules, and the like.

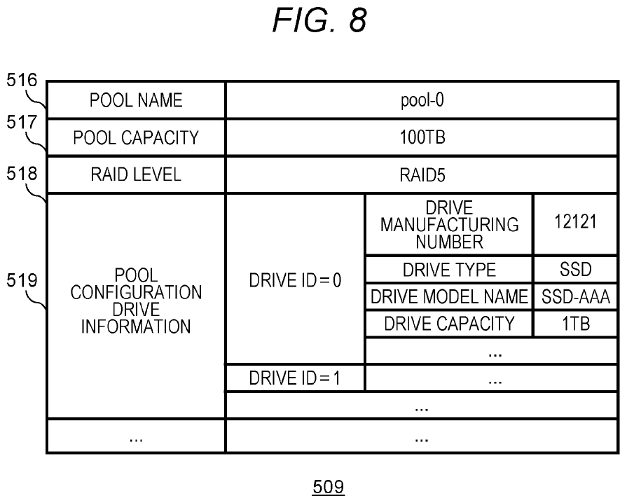

The pool information 503 is information related to the pool 207. The pool information 503 has a pool information structure 509, which is a data structure related to a pool, as an entry for each pool ID for identifying the pool. Details of the pool information structure 509 will be described later with reference to FIG. 8.

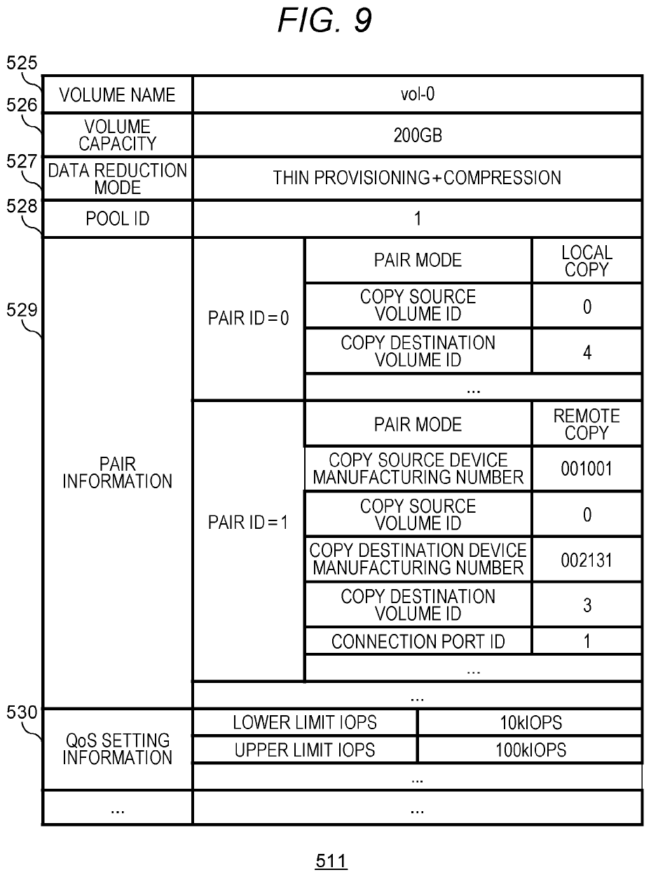

The volume information 504 is information related to the volume 208. The volume information 504 has a volume information structure 511, which is a data structure related to a volume, as an entry for each volume ID for identifying the volume. Details of the volume information structure 511 will be described later with reference to FIG. 9.

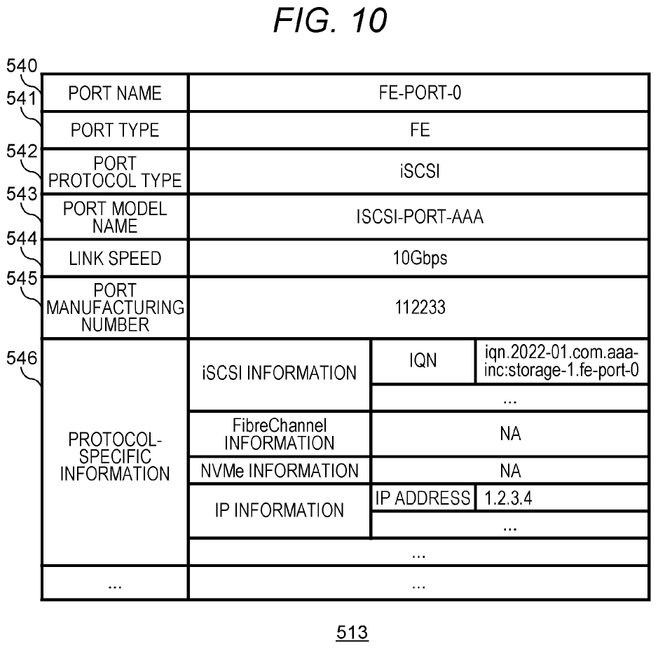

The port information 505 is information related to an interface (port) such as the FE-PORT 203, the MGMT-PORT 204, and the BE-PORT 205 constituting the storage apparatus 200. The port information 505 includes, as an entry, a port information structure 513, which is a data structure related to an interface, for each port ID that is identification information for identifying the interface. Details of the port information structure 513 will be described later with reference to FIG. 10.

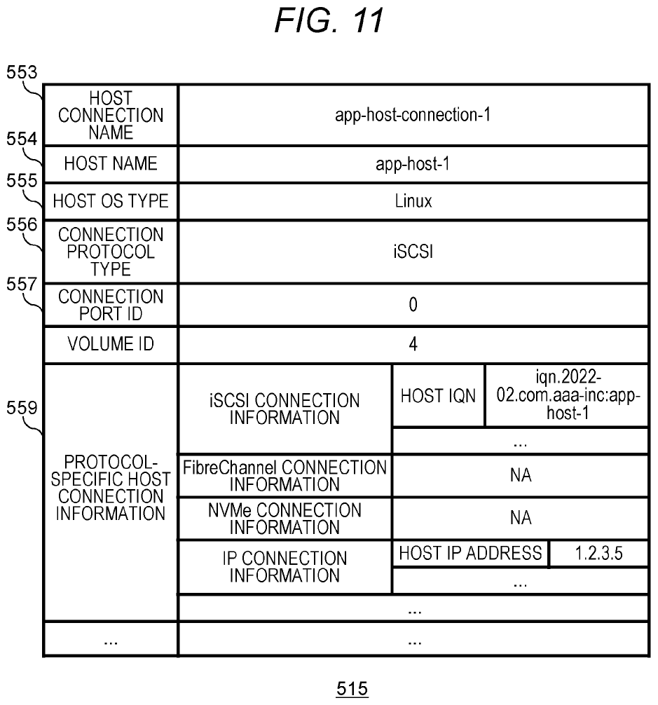

The host connection information 506 is information for managing the storage apparatus 200 and a connection relationship between the volume 208 provided by the storage apparatus 200 and the host 300. The host connection information 506 includes, as an entry, a host connection information structure 515, which is a data structure related to a connection relationship, for each connection ID that is identification information for identifying the connection relationship. Details of the host connection information structure 515 will be described later with reference to FIG. 11.

Note that the configuration information structure 501 is periodically transmitted from the information transmission unit 210 of the storage apparatus 200 to the management system 100, and is stored as the configuration information 500 in the information reception and storage unit 103 of the management system 100. In addition, information equivalent to the configuration information structure 501 is stored in the memory 202 of the storage apparatus 200, and the 10 processing unit 209 executes various processes such as data read and write processes using the information.

In addition, in FIG. 7, information related to the constituent elements existing inside the storage apparatus 200 is mainly illustrated as the information included in the configuration information structure 501, but the configuration information structure 501 may include external configuration information related to a constituent element existing outside the storage apparatus 200. The external configuration information is, for example, information related to the host 300 connected to the storage apparatus 200, an application program executed on the host 300, a network switch existing between the storage apparatus 200 and the host 300, a power supply such as a power distribution unit (PDU) or an uninterruptible power supply (UPS) that supplies power to the storage apparatus 200, or the like. In addition, the external configuration information may be collected by the storage apparatus 200 via the network 302 and transmitted to the management system 100, or an information collection agent having a function similar to that of the information transmission unit 210 may be provided inside each constituent element and transmitted to the management system 100 by the information collection agent.

FIG. 8 is a diagram illustrating an example of the pool information structure 509. The pool information structure 509 is a part of the configuration information structure 501, and is a data structure for managing setting values and parameters related to the pool 207. The pool information structure 509 exists for each of the pools 207.

The pool information structure 509 illustrated in FIG. 8 includes fields 516 to 519. The field 516 stores a pool name which is a name of the pool 207. The field 517 stores a pool capacity which is a capacity of data storable in the pool 207. The field 518 stores a RAID level indicating a data protection scheme applied to the pool 207. The field 519 stores pool configuration drive information which is information indicating the drives 206 constituting the pool.

The pool configuration drive information includes a drive manufacturing number, a drive type, a drive model name, and a drive capacity of the drive 206 for each drive ID which is identification information for identifying the drive 206 constituting the pool 207. The drive manufacturing number is identification information given at the time of manufacturing the drive 206. The drive type is information indicating a type of the drive 206, and indicates, for example, “SSD” or “HDD”. The drive model name indicates a model of the drive 206. The drive capacity indicates a storage capacity of the drive 206.

FIG. 9 is a view illustrating an example of the volume information structure 511. The volume information structure 511 is a part of the configuration information structure 501, and is a data structure for managing setting values and parameters related to the volume 208. The volume information structure 511 is present for each of the volumes 208.

The volume information structure 511 illustrated in FIG. 9 includes fields 525 to 530. The field 525 stores a volume name which is a name of the volume 208. The field 526 stores a volume capacity indicating a storage capacity of the volume 208. The field 527 stores a data reduction mode set for the volume 208. The data reduction mode indicates a function of reducing data, and indicates, for example, “thin provisioning”, “compression”, “deduplication”, a combination thereof, “invalid” indicating that the function of reducing data is not set, or the like. The field 528 stores a pool ID of the pool 207 to which the volume 208 is allocated. The field 529 stores pair information which is setting information related to a copy pair of the volume 208. The field 530 stores QoS setting information which is setting information related to a QoS function set in the volume 208.

The pair information has a pair mode, a copy source volume ID, and a copy destination volume as entries for each pair ID for identifying a copy pair. In addition, in a case where the copy pair is a copy pair of the remote copy function, the pair information further includes a copy source device manufacturing number, a copy destination device manufacturing number, and a connection port ID as entries.

The pair mode is information indicating an operating mode of the copy pair, and indicates “local copy”, “remote copy”, or the like. The copy source volume ID is a volume ID of the volume 208 of a copy source, and the copy destination volume ID is a volume ID of the volume 208 of a copy destination. The copy source device manufacturing number is a manufacturing number of the storage apparatus 200 having the volume 208 of the copy source, and the copy destination device manufacturing number is a manufacturing number of the storage apparatus 200 having the volume 208 of the copy destination. The connection port ID is a port ID of an interface used when data is copied.

In addition to the above-described information, the pair information may include information (for example, an IP address, authentication information, and the like) for performing communication with the other storage apparatus 200 constituting the copy pair. In addition, the pair information may include information indicating processing schemes of the local copy function and the remote copy function. The processing schemes of the local copy function include a scheme of copying data stored in the volume 208, a snapshot scheme of copying only management information of data stored in the volume 208, and the like. The processing schemes of the remote copy function include a scheme of copying data synchronously with reading and writing of data by the host 300, a scheme of copying data asynchronously with reading and writing of data by the host 300, and the like.

The QoS setting information has a lower limit input/output per second (IOPS) and an upper limit IOPS as an entry. The lower limit IOPS indicates the number of read and write operations (IOPS) per unit time guaranteed at the minimum for the volume 208. The upper limit IOPS indicates the upper limit of the number of read and write operations per unit time that can be executed by the host 300 with respect to the volume 208. Note that the QoS setting information may have a target response time, a priority of data read and write processes, or the like, instead of the lower limit IOPS and the upper limit IOPS.

FIG. 10 is a view illustrating an example of the port information structure 513. The port information structure 513 is a part of the configuration information structure 501, and is a data structure for managing setting values and parameters related to a port (interface) such as the MGMT-PORT 204, the FE-PORT 203, and the BE-PORT 205. The port information structure 513 is present for each port.

The port information structure 513 includes fields 540 to 546. The field 540 stores a port name which is a name of the port. The field 541 stores a port type that is a type of the port. The port type indicates “MGMT” when the port is the MGMT-PORT 204, indicates “FE” when the port is the FE-PORT 203, and indicates “BE” when the port is the BE-PORT 205. The field 542 stores a port protocol type indicating a communication protocol of the port. The port protocol type indicates, for example, “iSCSI”, “FibreChannel”, “NVMe”, “SAS”, “SATA”, “NVMeOF”, “IP”, or the like. The field 543 stores a port model name indicating a model name of the port. The field 544 stores a link speed of the port. The field 545 stores a port manufacturing number which is identification information given at the time of manufacturing the port. The field 546 stores protocol-specific information that is unique information according to the port protocol type.

The protocol-specific information includes information related to a communication protocol such as iSCSI information, FibreChannel information, NVMe information, and IP information. In the example of FIG. 10, the port protocol type is “iSCSI”, and thus, valid values are stored in the iSCSI information and the IP information in the protocol-specific information. For example, the iSCSI information stores a value related to an iSCSI qualified name (IQN) used in connection by iSCSI, and an IP address stores a value of an IP address of the port.

FIG. 11 is a view illustrating an example of the host connection information structure 515. The host connection information structure 515 is a part of the configuration information structure 501, and is a data structure for managing setting values and parameters related to a connection relationship between the host 300 and the volume 208. The host connection information structure 515 is present for each connection relationship between the host 300 and the volume 208.

The host connection information structure 515 includes fields 553 to 559. The field 553 stores a host connection name which is a name for simply identifying the connection relationship. The field 554 stores a host name which is a name of the host 300 related to the connection relationship. The field 555 stores a host operating system (OS) type indicating a type of an OS used in the host 300 related to the connection relationship. The field 556 stores a connection protocol type indicating a type of a protocol used for communication between the host 300 and the storage apparatus 200 that provides the volume 208 and the FE-PORT 203. The connection protocol type indicates “iSCSI”, “FibreChannel”, “NVMeoF”, or the like illustrated in FIG. 10. The field 557 stores a connection port ID which is a port ID of the FE-PORT 203 used by the host 300 for communication with the storage apparatus 200 in the connection relationship. The field 558 stores a volume ID of the volume 208 related to the connection relationship. The field 559 stores protocol-specific host connection information that is unique information according to the connection protocol type.

The protocol-specific host connection information includes information related to a communication protocol such as iSCSI connection information, FibreChannel connection information, NVMe connection information, and IP connection information 561. In the example of FIG. 11, the connection protocol type is “iSCSI”, and thus, valid values are stored in the iSCSI connection information and the IP connection information in the protocol-specific host connection information. For example, the iSCSI connection information stores a value indicating an IQN on the host side, and the host IP address stores a value of an IP address on the host side.

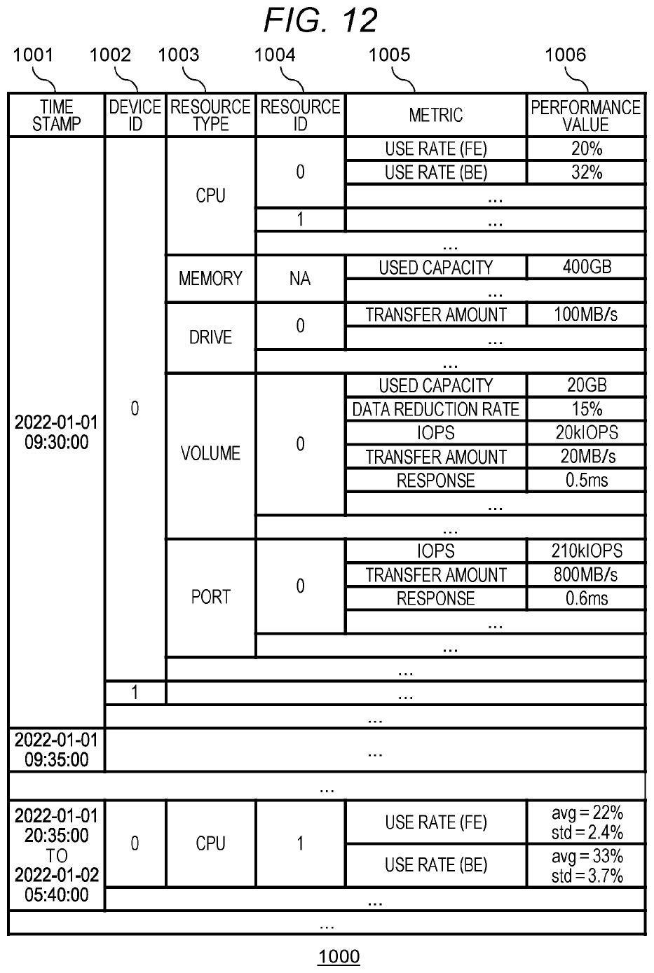

FIG. 12 is a view illustrating an example of the performance data 1000. The performance data 1000 is information indicating a performance value for each time related to each constituent element (resource) constituting the storage apparatus 200. As described above, the performance data 1000 is stored across the performance data temporary storage area 109, the high-cost performance data storage area 110, and the low-cost performance data storage area 111, and a specific storage format in each storage area may be different from that in the example of FIG. 12. Each entry of the performance data 1000 includes fields 1001 to 1006.

The field 1001 stores a time stamp indicating date and time related to the entry (for example, the date and time when the entry has been generated or the date and time when information related to the entry has been acquired). The field 1002 stores a device ID of the storage apparatus 200 that has acquired the information related to the entry. The field 1003 stores a resource type indicating a type of a constituent element (resource) corresponding to the information related to the entry. Specifically, as illustrated in FIG. 12, the resource types indicate types of physical and logical constituent elements related to the storage apparatus 200 such as “CPU”, “memory”, “drive”, “volume”, and “port”. In addition, the resource type may indicate, for example, a “pool”, a “copy pair”, or the like, in addition to the illustrated examples. In addition, the resource type may indicate a type of a constituent element existing outside the storage apparatus 200, such as the host 300, an application program executed on the host 300, a network switch, a PDU, or a UPS. The field 1004 stores a resource ID which is each ID for identifying a constituent element corresponding to the entry. For example, an entry having a resource type “volume” and a resource ID “0” indicates an entry related to the volume 208 whose volume ID is “0”. The field 1005 stores a metric indicating a type or an item of a performance value of a constituent element corresponding to the entry, and the field 1006 stores the performance value.

For example, an entry at the top of FIG. 12 indicates the performance data 1000 related to “CPU (ID=0)” acquired from the storage apparatus 200 having a device ID “0” at the date and time “2022-01-01 09:30:00” with a “use rate (FE)” of “20%”.

As will be described later, in a case where the performance data 1000 is stored in the high-cost performance data storage area 110, summary information in which pieces of the performance data 1000 indicating operation statuses in a predetermined summary period are summarized by statistical processing or the like is sometimes stored. In FIG. 12, an entry with a time stamp “2022-01-01 20:35:00 to 2022-01-02 05:40:00” is an example of the summary information in which pieces of the performance data 1000 are summarized. This example indicates that a “use rate (FE)” of “CPU” in the period of “2022 01-01 20:35:00 to 2022-01-02 05:40:00” is “22%” on average and a standard deviation is “2.4%”. Note that the statistical processing is not limited to the above example. For example, the summary information may be a model such as an approximate model or a mathematical model that is constructed using a machine learning method or a numerical analysis method and predicts a performance value from date and time.

Note that the information transmission unit 210 of the storage apparatus 200 periodically acquires performance values from the memory 202, the 10 processing unit 209, the respective constituent elements constituting the storage apparatus 200, and the like, and transmits the performance data 1000 indicating the acquired performance values to the management system 100. The information reception and storage unit 103 of the management system 100 receives the performance data and stores the performance data 1000 in the performance data temporary storage area 109. Thereafter, the storage destination selection unit 104 migrates the performance data 1000 stored in the performance data temporary storage area 109 to the high-cost performance data storage area 110 or the low-cost performance data storage area 111. The storage destination review unit 107 migrates the performance data 1000 between the high-cost performance data storage area 110 and the low-cost performance data storage area 111.

In addition, the performance data 1000 related to a constituent element existing outside the storage apparatus 200 may be collected by the storage apparatus 200 via the network 302 and transmitted to the management system 100, or an information collection agent having a function similar to that of the information transmission unit 210 may be provided inside each constituent element and transmitted to the management system 100 by the information collection agent.

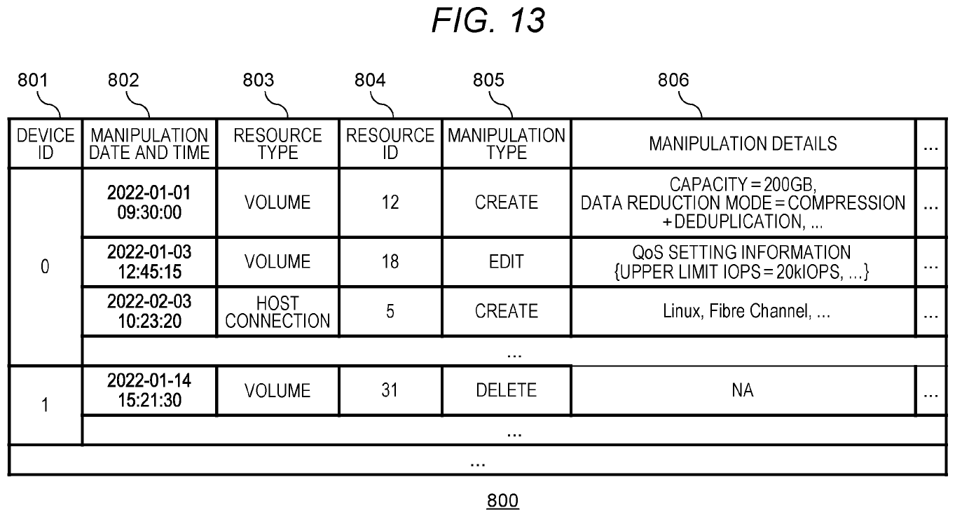

FIG. 13 is a view illustrating an example of the manipulation history information 800. The manipulation history information 800 is history information of a manipulation performed on the storage apparatus 200. Each entry of the manipulation history information 800 includes fields 801 to 806.

The field 801 stores a device ID of the storage apparatus 200 on which the manipulation (manipulation indicated by the entry) has been performed. The field 802 stores manipulation date and time which is date and time when the manipulation has been performed. The field 803 stores a resource type indicating a type of a constituent element targeted by the manipulation. The field 804 stores a manipulation type which is a classification type of the manipulation. The manipulation type indicates, for example, “create” indicating a manipulation for creating information, “edit” indicating a manipulation for editing information, “delete” indicating a manipulation for deleting information, or the like. The field 805 stores manipulation details indicating a content of the manipulation. The manipulation details are determined according to the resource type and the manipulation type of the manipulation.

For example, an entry at the top of FIG. 13 indicates a manipulation of creating a new volume 208 (volume ID=“12”) performed on the storage apparatus 200 having a device ID “0” at date and time “2022 01-01 09:30:00”.

The manipulation history information 800 is acquired from the respective units of the storage apparatus 200 by the information transmission unit 210 of the storage apparatus 200 and transmitted to the management system 100 as the manipulation history information 800, which is similar to the performance data 1000, the configuration information 500, and the like. The information reception and storage unit 103 of the management system 100 receives the manipulation history information 800 and adds the manipulation history information to the integrated management information 102. In addition, the manipulation history information 800 may include a history of a manipulation related to a constituent element existing outside the storage apparatus 200, which is similar to the performance data 1000, the configuration information 500, and the like.

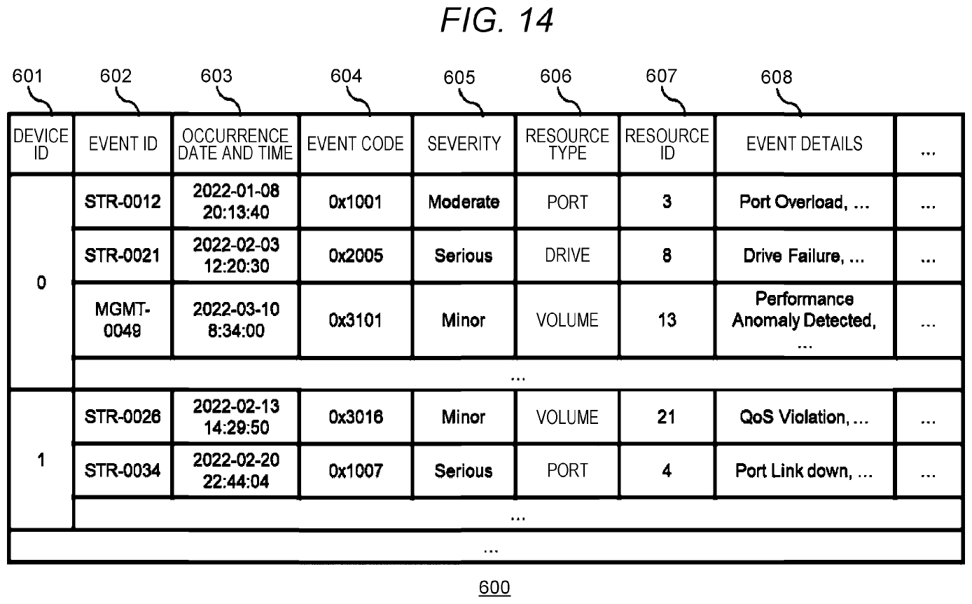

FIG. 14 is a view illustrating an example of the event history information 600. The event history information 600 is information for managing an event occurring in each of the constituent elements constituting the storage apparatus 200. Each entry of the event history information 600 includes fields 601 to 608. Note that examples of the event include an event detected by the storage apparatus 200 itself, such as a failure of the drive 206, an event detected by the device monitoring unit 106 and the device analysis unit 108 of the management system 100 from the performance data 1000, the configuration information 500, and the like.

The field 601 stores a device ID of the storage apparatus 200 in which the event (event indicated by the entry) has occurred. The field 602 stores an event ID for identifying the event. Although a format of the event ID is not limited, in the example of FIG. 14, an event ID starting with “STR-” indicates an event detected by the storage apparatus 200, and an event ID starting with “MGMT-” indicates an event detected by the management system 100. As a result, an event ID is prevented from overlapping between the entry by the storage apparatus 200 and the entry by the management system 100. The field 603 stores occurrence date and time which is date and time when the event has occurred. The field 604 stores an event code which is identification information for identifying a type of the event. The field 605 stores a severity of the event. In the example of FIG. 14, the severity indicates “Minor”, “Moderate”, and “Serious” in ascending order. The field 606 stores a resource type indicating a type of a constituent element in which the event has occurred, and the field 607 stores a resource ID of the constituent element. The field 608 stores event details indicating a content of the event.

For example, an entry at the top of FIG. 14 indicates that an event (event ID=“0012”) has occurred in the storage apparatus 200 having a device ID “0”, and the event “Port Overload” (event code=“0x1001”, severity=“Moderate”) has occurred in a port (ID=“3”) at date and time “2022-01-08 20:13:40”.

The event history information 600 is acquired from the respective units of the storage apparatus 200 by the information transmission unit 210 of the storage apparatus 200 and is transmitted to the management system 100 as the event history information 600, which is similar to the performance data 1000, the configuration information 500, and the like. The information reception and storage unit 103 of the management system 100 receives the event history information 600 and adds the event history information to the integrated management information 102. In addition, the event history information may include a history of an event related to a constituent element existing outside the storage apparatus 200, which is similar to the performance data 1000, the configuration information 500, and the like.

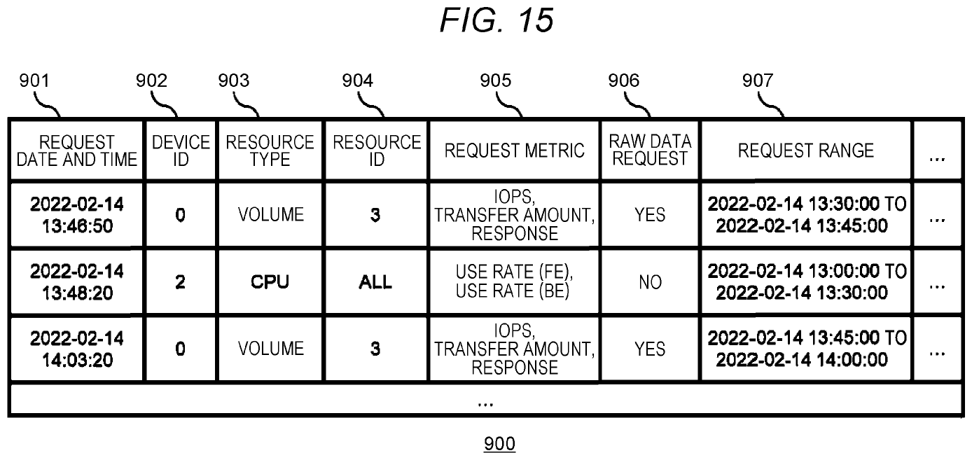

FIG. 15 is a diagram illustrating an example of the performance data provision history information 900. The performance data provision history information 900 is information for managing a history of provision of the performance data 1000 by the performance data providing unit 105 of the management system 100 in response to a reference request for the performance data 1000 by the management terminal 301 and the device analysis unit 108. Each entry of the performance data provision history information 900 includes fields 901 to 907.

The field 901 stores request date and time which is date and time when the performance data providing unit 105 receives the reference request. The field 902 stores a device ID of the storage apparatus 200 corresponding to the performance data requested to be referred by the reference request. The field 903 stores a resource type which is a type of a constituent element corresponding to the performance data requested by the reference request. The field 904 stores a resource ID of the constituent element corresponding to the performance data requested by the reference request. The field 905 stores a request metric which is a metric of the performance data requested by the reference request. The field 906 stores a raw data request indicating whether reference to raw data that is the performance data 1000 for which summarization has not been performed is requested. The raw data request indicates “Yes” if the raw data is requested and “No” if the raw data is not requested. The field 907 stores a request range indicating a range of time stamps of the performance data requested in the reference request.

For example, an entry at the top of FIG. 15 indicates that the performance data 1000 for which a summarization process in a period “2022-02-14 13:46:50 to 2022-02-14 13:45:00” has not been performed is requested for metrics “IOPS”, “transfer amount”, and “response” of the volume 208 (volume ID=“3”) of the storage apparatus 200 having a device ID “0” in a request received at date and time “2022-02-14 13:30:00”.

The entry of the performance data provision history information 900 is added each time the performance data providing unit 105 of the management system 100 receives a reference request for the performance data 1000.

Each piece of information of the integrated management information 102 described above is merely an example, and other information may be added as necessary, or unnecessary information may be deleted.

Next, processing performed in the storage system 1 will be described. Although descriptions of existing processes such as processes performed in a general storage system are appropriately omitted in the following description, but it is assumed that the processes are appropriately performed. For example, data read and write processes in the storage apparatus 200, various management processes such as creation and deletion of the volume 208, a collection process of the performance data 1000 and the configuration information 500 related to peripheral devices such as a network switch, a PDU, and a UPS, an authentication process for using the storage system 1, a communication encryption process between the management system 100 and the storage apparatus 200, error processing when an error or a failure occurs in various processes or constituent elements, and the like are omitted.

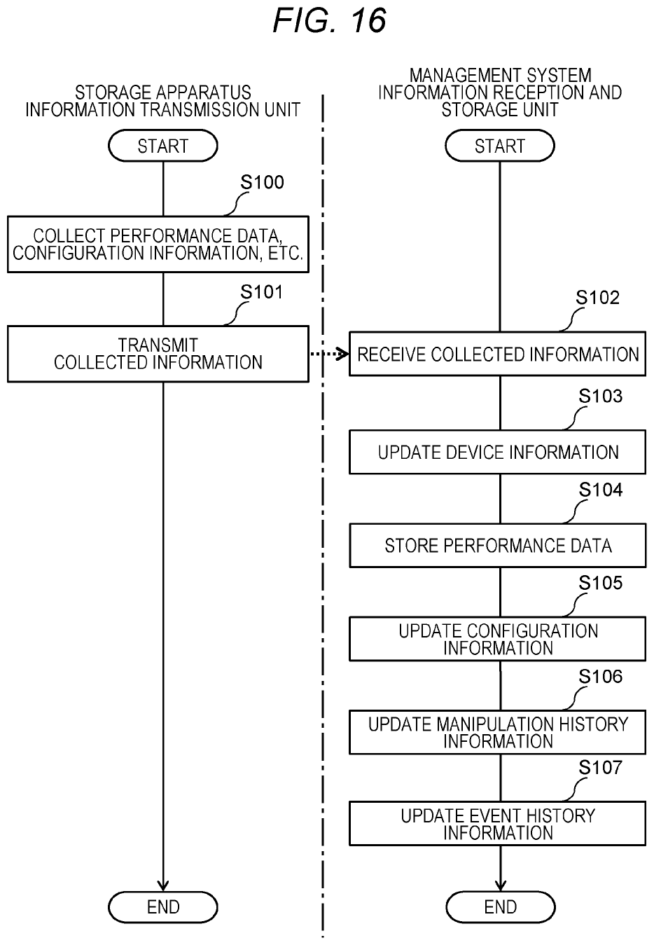

FIG. 16 is a flowchart for describing a collection and storage process of transmitting various types of information from the storage apparatus 200 to the management system 100 and storing the information in the integrated management information 102. This process corresponds to steps S1 and S2 in FIG. 1.

In the present embodiment, a push-type data transfer scheme from the storage apparatus 200 to the management system 100 is applied as a collection scheme in which the management system 100 collects information of each of the storage apparatuses 200. In addition, the collection and storage process is executed by the storage apparatus 200 at regular time intervals. As the collection scheme, a pull-type data transfer scheme in which the management system 100 requests the storage apparatus 200 to transfer data may be applied. In this case, the information reception and storage unit 103 of the management system 100 transmits a data transfer request to the storage apparatus 200 at regular time intervals.

In the collection and storage process, first, the information transmission unit 210 of the storage apparatus 200 collects information to be transmitted from the respective units of the storage apparatus 200 to the management system 100 (step S100). Specifically, the information transmission unit 210 collects information corresponding to the configuration information 500 (configuration information structure 501), the performance data 1000, the manipulation history information 800, and the event history information 600 in the integrated management information 102. Note that the information transmission unit 210 may perform a processing process of processing the collected information. For example, as the processing process, the information transmission unit 210 performs a process of converting a data format used inside the storage apparatus 200 into a data format used by the management system 100, a conversion process of converting a unit of a value of each piece of the information, and the like. Note that a device ID included in each piece of the information is information for the management system 100 to identify the storage apparatus 200, and the storage apparatus 200 is sometimes not grasped. For this reason, it is unnecessary to transmit the device ID to the management system 100, and for example, an invalid value is stored in a field for storing the device ID.

Subsequently, the information transmission unit 210 of the storage apparatus 200 communicates with the management system 100 and transmits each piece of the information collected in step S100 to the management system 100 (step S101). The management system 100 activates the information reception and storage unit 103 with this communication as a trigger. The information reception and storage unit 103 receives each piece of the information from the storage apparatus 200 (step S102).

The information reception and storage unit 103 updates the device information 700 of the integrated management information 102 based on the configuration information structure 501 included in the received information that is the information received in step S102 (step S103). Specifically, the information reception and storage unit 103 searches the device information 700 based on a model name and a manufacturing number included in the configuration information structure 501 to specify an entry and a device ID of the storage apparatus 200 that is a transmission source of the information. The information reception and storage unit 103 refers to or updates various types of information of the integrated management information 102 using the specified device ID in the subsequent processing. Thereafter, when a device name and location information in the entry of the device are different from information included in the device basic information 502 of the received configuration information structure 501, the information reception and storage unit 103 updates various pieces of information of the integrated management information 102 to match with the device basic information 502. Furthermore, the information reception and storage unit 103 updates latest reception date and time included in the entry of the device to the current time.

Next, the information reception and storage unit 103 stores the performance data 1000 included in the received information in the performance data temporary storage area 109 of the integrated management information 102 (step S104). Specifically, the information reception and storage unit 103 adds an entry corresponding to the performance data 1000 included in the received information to the performance data 1000 stored in the performance data temporary storage area 109.

The information reception and storage unit 103 updates the configuration information 500 of the integrated management information 102 using the configuration information structure 501 included in the received information (step S105). Specifically, the information reception and storage unit 103 updates (overwrites) the configuration information structure 501 regarding the storage apparatus 200 included in the configuration information 500 of the integrated management information 102 using the configuration information structure 501 included in the received information. At this time, the information reception and storage unit 103 also updates the pool information structure 509, the volume information structure 511, the port information structure 513, the host connection information structure 515, and the like included in the configuration information structure 501.

Next, the information reception and storage unit 103 updates the manipulation history information 800 of the integrated management information 102 using the manipulation history information 800 included in the received information (step S106). Specifically, the information reception and storage unit 103 specifies an entry not registered in the manipulation history information 800 of the integrated management information 102 in the manipulation history information 800 included in the received information, and adds the entry to the manipulation history information 800 of the integrated management information 102. As a method of specifying the unregistered entry, for example, there is a method of searching the manipulation history information 800 of the integrated management information 102 based on a device ID and manipulation date and time of each entry of the manipulation history information 800 included in the received information.

Then, the information reception and storage unit 103 updates the event history information 600 of the integrated management information 102 using the event history information 600 included in the received information (step S107), and ends the process. Specifically, the information reception and storage unit 103 specifies an entry not registered in the event history information 600 of the integrated management information 102 in the event history information 600 included in the received information, and adds the entry to the event history information 600 of the integrated management information 102. As a method of specifying the unregistered entry, there is a method of searching the event history information 600 of the integrated management information 102 based on a device ID and an event ID of each entry of the event history information 600 included in the received information. Note that the event ID in the event history information 600 included in the received information is information assigned by the storage apparatus 200 inside, and thus, may be replaced with a new ID by the management system 100 or may be subjected to conversion of an ID format or the like when being added to the integrated management information 102.

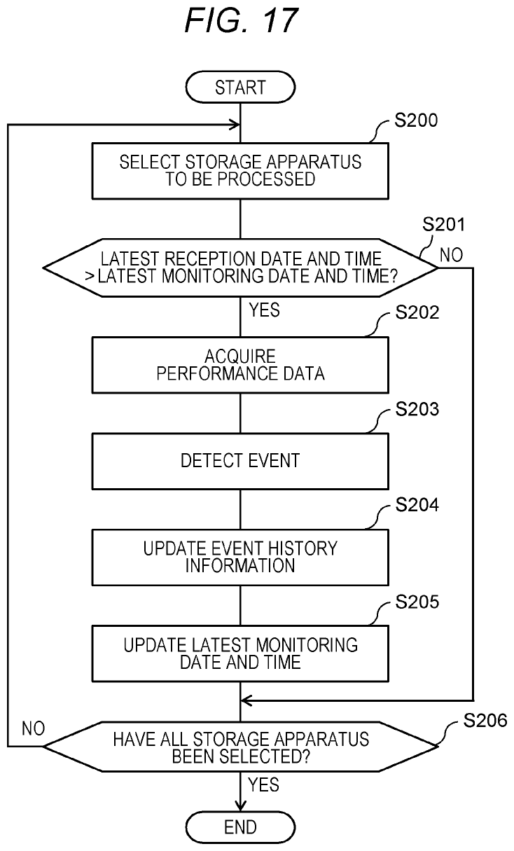

FIG. 17 is a flowchart for describing a problem point detection process of detecting the presence or absence of a problem point of the storage apparatus 200 (an event occurring in the storage apparatus 200) based on the performance data 1000 stored in the performance data temporary storage area 109. This process corresponds to step S3 in FIG. 1. In addition, this process is executed by the device monitoring unit 106 of the management system 100 at regular time intervals.

In the problem point detection process, first, the device monitoring unit 106 refers to the device information 700 of the integrated management information 102 and selects an entry of the storage apparatus 200 as a processing target (step S200).

Subsequently, the device monitoring unit 106 refers to the selected entry and determines whether latest reception date and time is later than latest monitoring date and time (step S201). When the entry has not been updated since a previously executed problem point detection process, there is no point in executing the problem point detection process again. In this determination, it is determined whether the entry has been updated.

When the latest reception date and time is not later than the latest monitoring date and time (step S201: No), processing of the following steps S202 to S205 is skipped. On the other hand, when the latest reception date and time is later than the latest monitoring date and time (step S201: Yes), the device monitoring unit 106 acquires the performance data 1000 related to the storage apparatus 200 to be processed from the performance data temporary storage area 109 (step S202). Specifically, the device monitoring unit 106 searches the performance data temporary storage area 109 for and acquires the performance data 1000 related to the storage apparatus 200 to be processed based on a device ID included in the entry of the device information 700.

Next, the device monitoring unit 106 detects the presence or absence of an event related to the storage apparatus 200 by analyzing the acquired performance data 1000 (step S203). A detection method of detecting the event is not particularly limited, and is, for example, a method of detecting an abrupt change in a performance value of each metric or a method of detecting that the performance value of each metric exceeds a threshold. Note that information other than the performance data may be referred to in this step.

Subsequently, when an event is detected, the device monitoring unit 106 registers an entry corresponding to the event in the event history information 600 of the integrated management information 102 (step S204). Specifically, the device monitoring unit 106 adds an entry having the current time as the occurrence date and time to the event history information 600, registers an event code, a severity, and event details corresponding to the detected event in the entry, and further registers a resource type and a resource ID of the acquired performance data 1000.

In addition, the device monitoring unit 106 updates the latest monitoring date and time included in the entry of the device information 700 corresponding to the storage apparatus 200 to be processed to the current time (step S205).

Then, the device monitoring unit 106 determines whether all the entries of the device information 700 have been selected (step S206). The device monitoring unit 106 ends the process when all the entries are selected (step S206: Yes), and returns to the process of step S200 to select another entry when not all the entries are selected (step S206: No).

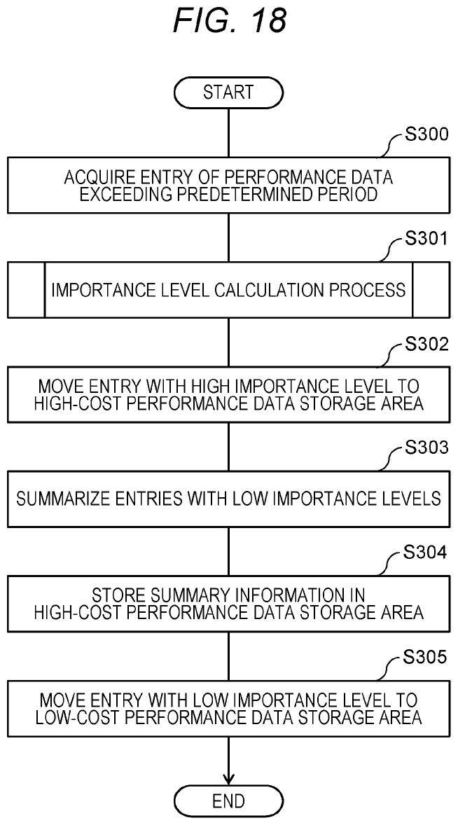

FIG. 18 is a flowchart for describing a storage destination selection process of migrating the performance data 1000 stored in the performance data temporary storage area 109 to either the high-cost performance data storage area 110 or the low-cost performance data storage area 111. This process corresponds to step S4 in FIG. 1. In addition, this process is executed by the storage destination selection unit 104 of the management system 100 at regular time intervals.

In the storage destination selection process, first, the storage destination selection unit 104 acquires an entry of the performance data 1000 for which a predetermined temporary storage period has elapsed since storage from the performance data temporary storage area 109 (step S300). Specifically, the storage destination selection unit 104 compares date and time indicated by a time stamp with current date and time for each of entries of the performance data 1000 stored in the performance data temporary storage area 109, and acquires an entry in which the temporary storage period has elapsed from the date and time indicated by the time stamp. The temporary storage period is a period in which the performance data 1000 is stored in the performance data temporary storage area 109, and is appropriately set such that the problem point detection process by the device monitoring unit 106 described with reference to FIG. 17 is appropriately performed.

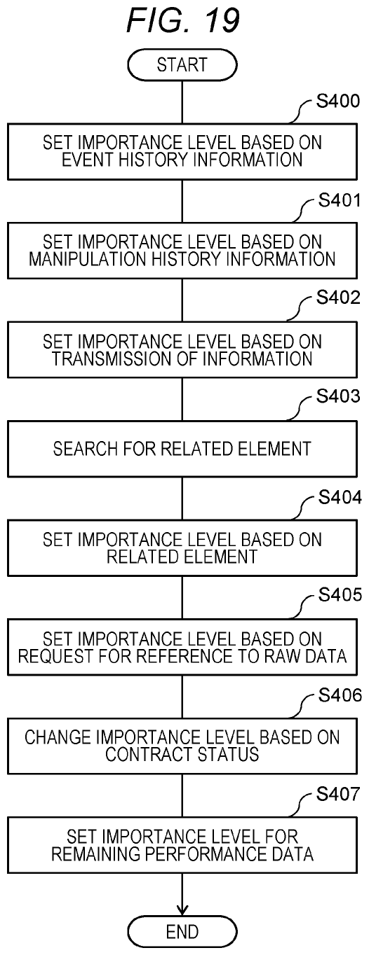

Subsequently, for each of the entries of the acquired performance data 1000, the storage destination selection unit 104 executes an importance level determination process of determining an importance level indicating a degree of an influence on an analysis process of analyzing the storage apparatus 200 by the device analysis unit 108 or the management terminal 301 to detect the presence or absence of an event (step S301). The importance level determination process will be described later in more detail with reference to FIG. 19. In the present embodiment, the importance level indicates either “high” which is a first importance level with higher importance or “low” which is a second importance level with lower importance.

The storage destination selection unit 104 migrates an entry in which the importance level “high” has been set from the performance data temporary storage area 109 to the high-cost performance data storage area 110 (step S302).

In addition, the storage destination selection unit 104 executes a summarization process of generating summary information in which a content of the entry is summarized by performing statistical processing or the like on entries in which the importance level “low” has been set (step S303). In the summarization process, for example, the storage destination selection unit 104 calculates statistical values such as an average value and a standard deviation for performance values of a plurality of entries having consecutive time stamps and the same metric (also having the same resource type and the same resource) of the same device ID, and generates an entry having the statistical values as performance values as the summary information. Note that it is unnecessary to summarize all the entries in which the importance level “low” is set into a single entry. In addition, entries having different device IDs, different resource types, different resource IDs, and different metrics are summarized separately. In addition, in a case where there is a plurality of periods in which time stamps are not consecutive even if the same metric is included, the entry may be summarized for each period in which time stamps are consecutive.

Note that the summarization process is not limited to the above-described example, and may be any process that can summarize a plurality of entries. For example, the summarization process may be a process of constructing a model such as an approximate model or a mathematical model that predicts a performance value from date and time using machine learning or numerical analysis, and using the model as summary information. In addition, the summarization process may be a process of setting entries with consecutive time stamps as time-series data and performing lossy compression on the time-series data. In the lossy compression, some amount of information is generally lost, and noise is included in the decompressed time-series data, but it is possible to realize a high compression rate and an increase in speed of compression and decompression processing.

Next, the storage destination selection unit 104 stores the summary information in the high-cost performance data storage area 110 as an entry of the performance data 1000 (step S304).

Then, the storage destination selection unit 104 migrates the entry in which the importance level “low” is set to the low-cost performance data storage area 111 (step S305), and ends the process.

FIG. 19 is a flowchart for describing the importance level determination process in step S301 of FIG. 18.

In the importance level determination process, first, the storage destination selection unit 104 refers to the event history information 600, and sets the importance level “high” to an entry within a target period (specifically, a certain period before and after occurrence date and time) in which a time stamp includes the occurrence date and time of an event among entries of the performance data 1000 corresponding to a constituent element in which the event has occurred (step S400). Specifically, the storage destination selection unit 104 sets the importance level “high” to the entry in which the time stamp is included in the certain period before and after the occurrence date and time among the entries of the performance data 1000 with which a device ID, a resource type, and a resource ID of the event history information 600 match. A target entry to which the importance level “high” is to be set may be all the entries or some entries according to a metric, an event code, a severity level, event details, and the like. For example, as the target entry, the importance level “high” may be set only to an entry whose severity is “Moderate” or “Serious”. The target period may be a predetermined fixed period, or may be variable according to an event code, a severity, event details, and the like. For example, a longer target period may be set as the severity is higher.

With the process in this step, for example, when the event occurs in a part of the constituent elements of the storage apparatus 200, an importance level of the performance data 1000 in a certain period before and after a failure occurs out of pieces of the performance data 1000 related to the constituent elements becomes high. The event is a hardware failure, overload, QoS violation, or the like. As a result, pieces of the performance data 1000 at a starting time of a change in the performance data 1000, caused by the event occurring in the storage apparatus 200, and before and after the starting time are stored in the high-cost performance data storage area 110.

Next, the storage destination selection unit 104 refers to the manipulation history information 800, and sets the importance level “high” to an entry within a target period (specifically, a certain period before and after the manipulation date and time) in which a timestamp includes the manipulation date and time of a manipulation for entries of the performance data 1000 of constituent elements as targets of various manipulations performed on the storage apparatus 200 (step S401). Specifically, the storage destination selection unit 104 sets the importance level “high” to the entry in which the time stamp is included in the certain period before and after the manipulation date and time among the entries of the performance data 1000 with which a device ID, a resource type, and a resource ID of the manipulation history information 800 match. The target period may be a fixed period or may be variable according to a manipulation type, manipulation details, and the like. For example, the storage destination selection unit 104 may extend the target period in a case of a manipulation of changing the setting of an item having a large influence on processing performance of data reading and writing of the volume 208 such as the data reduction mode in the volume information structure 511, and may shorten the target period or remove the entry from target entries in a case of a manipulation of changing a name such as a volume name.

With the process in this step, for example, when a manipulation that is likely to cause a problem in the storage apparatus 200 is performed, the importance level of the performance data 1000 in a certain period before and after the manipulation has been performed out of pieces of the performance data 1000 of a resource as a target of the manipulation becomes high. As a result, pieces of the performance data 1000 at the starting time and before and after the starting time regarding the change in the performance data 1000 caused by the manipulation of the administrator are stored in the high-cost performance data storage area 110.

Next, the storage destination selection unit 104 refers to latest reception date and time of the device information 700 and sets the importance level “high” in the performance data 1000 of the storage apparatus 200 to which information has not been transmitted for a predetermined period or more (step S402). In a case where the storage apparatus 200 does not transmit information, there is a possibility that a serious problem that the storage apparatus 200 becomes inoperable has occurred. For this reason, there is a possibility that information before the problem occurs indicates a sign of the problem, and the importance level thereof is high.

Next, the storage destination selection unit 104 refers to the configuration information 500 and executes a search process of searching for a related element, which is a constituent element related to a constituent element corresponding to the performance data 1000 for which the importance level “high” is set in the processes of steps S400 to S402 (step S403). Examples of the search process include a method of deriving relevance between constituent elements from the configuration information structure 501 and the like. In addition, the search process varies depending on a type of a constituent element serving as a search source.

For example, when searching for a constituent element related to the volume 208, the storage destination selection unit 104 refers to a pool ID of the volume information structure 511 of the corresponding volume 208 to specify the pool 207 allocating a storage area to the corresponding volume 208. The storage destination selection unit 104 refers to pool configuration drive information of the pool information structure 509 for the specified pool 207 to specify the drive 206 storing data of the corresponding volume 208. The storage destination selection unit 104 refers to the volume information structures 511 related to the volumes 208 other than the corresponding volume 208 and searches for a volume having the same pool ID as the corresponding volume 208, thereby specifying the volume 208 belonging to the same pool 207 as the corresponding volume 208. In addition, the storage destination selection unit 104 searches the host connection information structure 515 whose volume ID indicates the corresponding volume 208 to specify the host 300 connected to the corresponding volume 208 and a port used for the connection. The storage destination selection unit 104 can set each constituent element specified in this manner as a related element.

Note that the related element is not necessarily present inside the storage apparatus 200. For example, in a case where a constituent element of a search source is the volume 208 and there is a copy pair whose pair mode is “remote copy” with respect to the volume 208 as a result of referring to pair information of the volume information structure 511, the storage destination selection unit 104 may specify the storage apparatus 200 and the volume 208 constituting the copy pair as related elements by searching the device information 700 and the configuration information 500 using a copy destination device manufacturing number, a copy source device manufacturing number, a copy source volume ID, and a copy destination volume ID.

In the search process, a recursive search process of further specifying a constituent element related to the related element as a related element may be performed. In this case, when the recursive search process is repeated many times, many constituent elements become related elements, and almost all the constituent elements are likely to be specified as related elements in some cases. For this reason, it is desirable that the recursive search process ends at an appropriate timing, for example, a timing when the number of times of regression reaches a threshold. The number of times of regression may be fixed or may be variable according to a type of a constituent element of a search source.

The storage destination selection unit 104 sets the importance level “high” to an entry having the same metric and the same period as the constituent element of the search source among entries of the performance data 1000 corresponding to the related element (step S404). Note that the related element related to the constituent element corresponding to the performance data 1000 having the high importance level is often related to a cause of the event or the like, and thus, is considered to have a high importance level.

Next, the storage destination selection unit 104 refers to the performance data provision history information 900, and sets the importance level “high” to an entry for which a reference request for raw data on which the summarization process has not been performed is made among entries of the performance data 1000 for which the reference requests have been made within a past predetermined period (step S405). Specifically, the storage destination selection unit 104 refers to the performance data provision history information 900, and sets the importance level “high” to an entry of the performance data 1000 corresponding to a resource type, a resource ID, and a request metric among entries with a raw data request “Yes” included in the entries within the past predetermined period. The predetermined period may be fixed or may be variable according to a resource type.

The process in this step is performed in consideration of so-called reference locality of data. That is, the performance data 1000 for which the reference request for the raw data has been made in the past is stored in the high-cost performance data storage area 110 since it is considered that there will be a similar request in the future.

Next, the storage destination selection unit 104 refers to the organization information 400 and the device information 700 among the entries in which the importance level “high” is set, and changes an entry of the performance data 1000 with respect to the storage apparatus 200 of the organization whose contract status is “Inactive” to the importance level “low” (step S406). Specifically, the storage destination selection unit 104 acquires an organization ID of an organization that owns the storage apparatus 200 from the respective entries of the device information 700, and acquires an entry of the organization by searching the organization information 400 based on the acquired organization ID. When s contract status in the entry of the organization is “Inactive”, the storage destination selection unit 104 changes an importance level of the entry of the performance data 1000 for the storage apparatus 200 to “low”.

This is because it is unnecessary to execute a problem detection function or the like based on advanced analysis for the storage apparatus 200 owned by the organization whose contract for the use of the management system 100 is expired. Note that an importance level may be changed according to a contract type in a case where a contract status indicates the contract type. For example, an importance level may be set to “low” in the performance data 1000 of the storage apparatus 200 owned by an organization whose contract status is “Active (Basic)” although the contract is valid.

Then, the storage destination selection unit 104 sets the importance level “low” to an entry of the performance data 1000 for which no importance level has been set in each determination process of steps S400 to S406 (step S407), and ends the process.

Note that the importance level determination process described above is an example, and a determination process different from the above example may be added, or at least a part of the above determination process is not necessarily performed. The different determination process is, for example, a process of setting the importance level “high” to performance data corresponding to a constituent element providing a device resource or a constituent element sharing the device resource to or with a constituent element corresponding to the performance data 1000 to which the importance level “high” is set. In addition, the storage destination selection unit 104 may perform scoring regarding an importance level for each of entries in each of the determination processes and determine the importance level based on a weighted sum of the scores in the respective determination processes or the like.

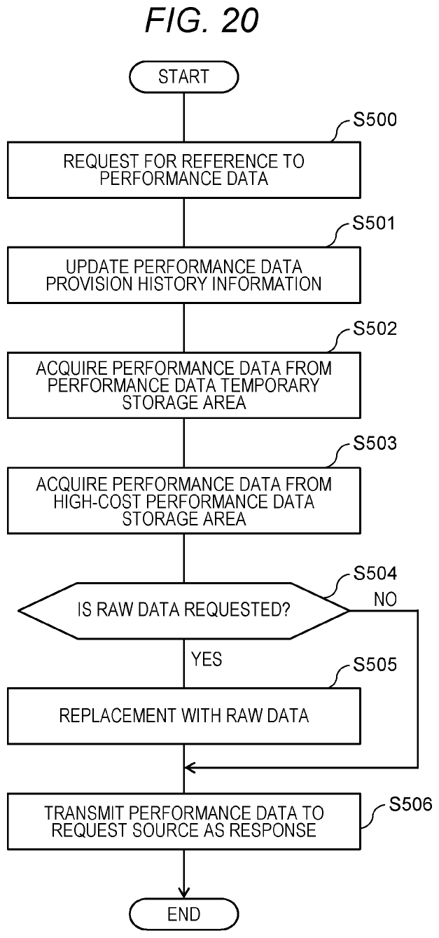

FIG. 20 is a flowchart for describing a provision process of providing the performance data 1000 to the device analysis unit 108 and the management terminal 301. The provision process corresponds to step S5 in FIG. 1. In addition, this process is executed by the performance data providing unit 105 of the management system 100 in response to a reference request of the performance data 1000 from the device analysis unit 108 or the management terminal 301.

In the provision process, first, the performance data providing unit 105 receives a reference request for the performance data 1000 from the device analysis unit 108 or the management terminal 301 (step S500). The reference request includes information for designating the performance data 1000 to be referred to, for example, a device ID, a resource type, a resource ID, a request metric, a raw data request, a request range, and the like. Note that the raw data request indicates “Yes”, for example, in a case where analysis using the performance data 1000 is strictly performed, or in a case where it is necessary to prove an operation status by the performance data 1000 that does not use summary information based on a law, a contract, or the like. In addition, a transmission source of the reference request may be other than the device analysis unit 108 and the management terminal 301.

Subsequently, the performance data providing unit 105 registers an entry corresponding to the reference request in the performance data provision history information 900 (step S501). Specifically, the performance data providing unit 105 adds a new entry to the performance data provision history information 900, registers the device ID, the resource type, the resource ID, the request metric, the raw data request, and the request range included in the reference request with respect to the entry, and further registers date and time when the reference request has been received as request date and time.

Next, the performance data providing unit 105 acquires the performance data 1000 stored in the performance data temporary storage area 109 among pieces of the performance data 1000 requested by the reference request from the area (step S502). Thereafter, the performance data providing unit 105 acquires, from the high-cost performance data storage area 110, the performance data 1000 stored in the performance data 1000 requested by the reference request (step S503). When summary information of the performance data 1000 requested to be referred to is stored in the high-cost performance data storage area 110, the performance data providing unit 105 also acquires the summary information.

Next, the performance data providing unit 105 determines whether the reference request requests raw data. In a case where the raw data is not requested (step S504: No), the process of the following step S505 is skipped. On the other hand, when the raw data is requested (step S504: Yes), the performance data providing unit 105 acquires the raw data (performance data 1000) corresponding to the summary information included in the performance data 1000 acquired in step S503 from the low-cost performance data storage area 111, and replaces the summary information with the acquired raw data (step S505).

Then, the performance data providing unit 105 transmits the performance data 1000 acquired in steps S502 to S505 to the transmission source of the reference request (step S506), and ends the process. The performance data providing unit 105 may perform processing such as data shaping processing on the performance data 1000. For example, in a case where lossy compression is used as a summarization process, the performance data providing unit 105 may perform decompression processing on the summarization process to return a data format to a data format equivalent to that of the performance data 1000 that is not summarized.

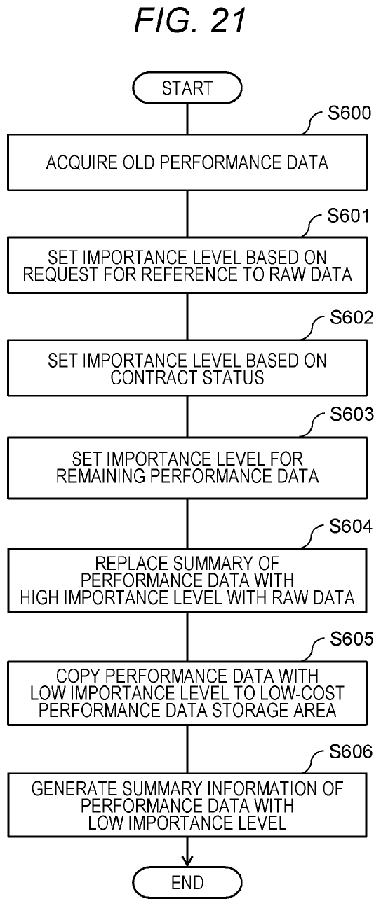

FIG. 21 is a flowchart for describing a storage destination review process of changing storage destinations of pieces of the performance data 1000 stored in the high-cost performance data storage area 110 and the low-cost performance data storage area 111. The storage destination review process corresponds to step S7 in FIG. 1. The storage destination review process is executed by the storage destination review unit 107 of the management system 100 at regular time intervals.

In the storage destination selection unit 104, the storage destination is determined by determining an importance level of the performance data 1000 for each entry based on the integrated management information 102, but there is a possibility that the determination of the importance level is not appropriate or there is an entry that is frequently referred to due to operational convenience or the like regardless of an importance level. The storage destination review process is a process of changing a storage destination of an entry of the old performance data 1000 for which a predetermined review period has elapsed since storage based on a provision status of the performance data 1000 by the performance data providing unit 105 in response to a reference request.

In the storage destination review process, first, the storage destination review unit 107 refers to a time stamp and acquires an entry of the old performance data 1000 for which a predetermined review period has elapsed since storage from pieces of the performance data 1000 stored in the high-cost performance data storage area 110 (step S600). The review period is preferably a relatively long period such that a storage destination is not frequently changed, and is, for example, a period on the order of several months to years.

Next, the storage destination review unit 107 refers to the performance data provision history information 900, and sets the importance level “high” to an entry of the performance data 1000 corresponding to a constituent element for which a reference request for raw data that is not summarized has been made within the review period (step S601). Specifically, the storage destination review unit 107 acquires an entry in which request date and time is within the review period and the raw data request is “Yes” from the performance data provision history information 900, and sets the importance level “high” to an entry of the performance data 1000 corresponding to a device ID, a resource type, a resource ID, a request metric, and a request range of the entry. As a result, the entry of the performance data 1000 set as a target of the reference request for the raw data has the high importance level and is stored in the high-cost performance data storage area 110.

Subsequently, the storage destination review unit 107 refers to the organization information 400 and the device information 700 and sets the importance level “low” to an entry of the performance data 1000 for the storage apparatus 200 owned by an organization whose contract status is “Inactive” (step S602). In general, a contract for using the management system 100 and a maintenance contract of the storage apparatus 200 are fixed-term contracts, there is a case where the contracts expire after the storage destination selection process is performed in the storage destination selection unit 104. In a case where the contract expires, it is unnecessary to perform advanced analysis, and thus, the importance level “low” is set to such an entry in this process.

The storage destination review unit 107 sets the importance level “low” to an entry of the performance data for which no importance level has been set in the processes of steps S601 to S602 (step S603).

The storage destination review unit 107 replaces summary information included in the entry of the performance data 1000 set to the importance level “high” with raw data stored in the low-cost performance data storage area 111 corresponding to the summary information (step S604).

The storage destination review unit 107 copies an entry which is not summarized out of the summary information included in the entry of the performance data 1000 set to the importance level “low” to the low-cost performance data storage area 111 (step S605).

Then, the storage destination review unit 107 generates summary information of an entry that is not summarized among entries of the performance data 1000 set to the importance level “low” and executes a summarization process of replacing the entry with the summary information (step S606), and ends the process. The summarization process in this step is similar to the summarization process described in step S303 of FIG. 18.

As described above, according to the present embodiment, the processor 3 repeatedly collects the integrated management information 102 related to the storage apparatus 200 and including the performance data 1000 indicating the operation status of the storage apparatus that stores data, and stores the performance data 1000 in the performance data temporary storage area 109. In addition, the processor 3 analyzes the integrated management information 102, and determines the importance level indicating the degree of the influence of the performance data 1000 stored in the performance data temporary storage area 109 on the analysis process of analyzing the performance data. The processor 3 migrates the performance data 1000 stored in the performance data temporary storage area 109 to one of the plurality of long-term storage areas having different characteristics based on the importance level. For this reason, it is possible to reduce the storage cost for storing the performance data 1000 while suppressing the influence on the analysis process for analyzing the performance data 1000.

In the present embodiment, the importance level indicates either “high” or “low”, and the processor 3 stores the performance data 1000 with the importance level “high” in the high-cost performance data storage area 110 having high performance and stores the performance data 1000 with the importance level “low” in the low-cost performance data storage area 111 having low performance. For this reason, the performance data 1000 can be stored in an appropriate storage area according to the importance level, and thus, the influence on the analysis process can be more appropriately suppressed.

In the present embodiment, the processor 3 generates summary information in which a content of the performance data 1000 with the importance level “low” is summarized, and stores the summary information in the high-cost performance data storage area 110. For this reason, the analysis process using the summary information can be performed, and thus, it is possible to further suppress the influence on the analysis process of analyzing the performance data 1000.

In the present embodiment, the processor 3 executes a device monitoring process of detecting the occurrence of an event in the storage apparatus 200 based on the performance data 1000 stored in the performance data temporary storage area 109, and determines an importance level of the performance data 1000 based on a processing result of the device monitoring process. More specifically, the processor 3 sets the importance level of the performance data 1000 corresponding to a target period including occurrence date and time of the event to “high”. For this reason, the performance data 1000 related to the event considered to be important can be stored in the high-cost performance data storage area 110, and thus, the performance data 1000 can be stored in an appropriate storage area according to the importance level.

In the present embodiment, when the integrated management information 102 is not collected for a certain period, the processor 3 sets an importance level of the performance data 1000 included in the integrated management information 102 collected last to “high”. Since it is possible to store the performance data 1000 of the storage apparatus 200 in which there is a possibility that a serious problem that makes transmission of information difficult has occurred in the high-cost performance data storage area 110, and thus, it is possible to store the performance data 1000 in an appropriate storage area according to the importance level.

In the present embodiment, the processor 3 sets an importance level of the performance data 1000 corresponding to a resource corresponding to a manipulation on the storage apparatus 200 as the first importance level. For this reason, the performance data 1000 that changes due to the manipulation can be stored in the high-cost performance data storage area 110, the performance data 1000 can be stored in an appropriate storage area according to the importance level.

In addition, an importance level of a related resource related to a resource having a high importance level is also set to be high in the present embodiment, and thus, the performance data 1000 can be stored in an appropriate storage area according to the importance level.

In the present embodiment, the processor 3 migrates the performance data 1000 stored in the long-term storage area to another long-term storage area based on a reference request for the performance data 1000. For this reason, the performance data 1000 can be stored in a more appropriate storage area.

Although the main embodiment of the present invention has been described above, this is an example for describing the invention, and there is no intention to limit the scope of the invention only to the embodiment. All the configurations described above are not necessarily provided, and a partial configuration of a certain embodiment may be replaced with or added to a configuration of another embodiment. Similarly, a partial configuration of each embodiment can be changed or deleted as necessary.

For example, the long-term storage area may include three or more areas having different characteristics. In this case, the importance level of the performance data is determined in three or more stages, for example, and is stored in the long-term storage area according to the importance level.

What is claimed is:

1. A management system that performs an analysis process of analyzing performance data indicating an operation status of a storage apparatus that stores data,
the management system comprising a processor,
wherein the processor executes
a collection process of repeatedly collecting management information related to the storage apparatus and including the performance data and storing the performance data in a temporary storage area,
an importance level determination process of analyzing the management information and determining an importance level indicating a degree of an influence of the performance data stored in the temporary storage area on the analysis process, and
a migration process of migrating the performance data stored in the temporary storage area to one of a plurality of long-term storage areas having different characteristics based on the importance level.

2. The management system according to claim 1, wherein
the long-term storage area includes a first storage area and a second storage area having lower performance than the first storage area,
the importance level is one of a first importance level and a second importance level having a lower degree of the influence than the first importance level, and
the processor migrates the performance data of the first importance level to the first storage area and migrates the performance data of the second importance level to the second storage area in the migration process.

3. The management system according to claim 2, wherein the processor generates summary information in which a content of the performance data of the second importance level is summarized and stores the summary information in the first storage area in the migration process.

4. The management system according to claim 2, wherein
the processor
executes a device monitoring process of detecting occurrence of an event in the storage apparatus based on the performance data stored in the temporary storage area, and
determines the importance level of the performance data based on a processing result of the device monitoring process in the importance level determination process.

5. The management system according to claim 4, wherein the processor sets the importance level of the performance data corresponding to a target period including occurrence date and time of the event as the first importance level in the importance level determination process.

6. The management system according to claim 2, wherein the processor sets the importance level of the performance data included in the management information collected last as the first importance level when the management information is not collected for a certain period in the importance level determination process.

7. The management system according to claim 2, wherein
the performance data is provided for each resource related to the storage apparatus,
the management information includes manipulation history information indicating a history of a manipulation related to the resource, and
the processor sets the importance level of the performance data corresponding to the resource according to the manipulation as the first importance level in the importance level determination process.

8. The management system according to claim 2, wherein
the performance data is provided for each resource related to the storage apparatus, and
the processor sets an importance level of a related resource related to manipulation resource corresponding to the performance data for which the importance level is determined to be the first importance level as the first importance level in the importance level determination process.

9. The management system according to claim 8, wherein
the storage apparatus forms a pair with another storage apparatus to which the data is to be copied, and
the related resource includes a resource of the other storage apparatus forming the pair.

10. The management system according to claim 1, wherein
the processor executes
a reference process of reading the performance data according to a reference request from the temporary storage area and the long-term storage area and providing the performance data to a request source of the reference request when the reference request for the performance data is received, and
a review process of migrating the performance data stored in the long-term storage area to another long-term storage area based on the reference request.

11. A storage system comprising:
the management system according to claim 1; and
the storage apparatus.

12. A management processing method executed by a management system that performs an analysis process of analyzing performance data indicating an operation status of a storage apparatus that stores data,
the management processing method comprising:
repeatedly collecting management information related to the storage apparatus and including the performance data indicating the operation status of the storage apparatus and storing the performance data in a temporary storage area;
analyzing the management information and determining an importance level indicating a degree of an influence of the performance data stored in the temporary storage area on the analysis process; and
migrating the performance data stored in the temporary storage area to one of a plurality of long-term storage areas having different characteristics based on the importance level.
